(19) United States
(12) Patent Application Publication
(10) Pub. No.: US 2025/0328194 A1
(43) Pub. Date: Oct. 23, 2025

(54) METHOD FOR SUPPORTING HAPTIC SERVICE BASED ON HAPTIC CONTENT, AND ELECTRONIC DEVICE FOR SUPPORTING SAME

(71) Applicant: SAMSUNG ELECTRONICS CO., LTD., Suwon-si (KR)

(72) Inventors: Minjee KIM, Suwon-si (KR); Jeongwook KWON, Suwon-si (KR); Sangheon KIM, Suwon-si (KR); Chunbae PARK, Suwon-si (KR); Dahye YOON, Suwon-si (KR); Yeunwook LIM, Suwon-si (KR)

(73) Assignee: SAMSUNG ELECTRONICS CO., LTD., Suwon-si (KR)

(21) Appl. No.: 19/255,179

(22) Filed: Jun. 30, 2025

Related U.S. Application Data
(63) Continuation of application No. PCT/KR2023/021732, filed on Dec. 27, 2023.

(30) Foreign Application Priority Data
Dec. 30, 2022 (KR) 10-2022-0190617
Jan. 30, 2023 (KR) 10-2023-0011991

(51) Int. Cl. G06F 3/01

(52) U.S. Cl. CPC G06F 3/016

(57) ABSTRACT

Provided is an electronic device and a method of operating same, the electronic device including: a haptic driver; memory storing instructions; and at least one processor operatively connected to the haptic driver and the memory, wherein the instructions, when executed by the at least one processor individually or collectively, cause the electronic device to: sense playback of haptic content by the electronic device; identify, in the haptic content, an index corresponding to a combination of minimum unit vibration patterns for haptic feedback; combine the minimum unit vibration patterns based on the index to generate vibration data for haptic content; and provide the haptic feedback based on the vibration data using the haptic driver.

### CROSS-REFERENCE TO RELATED APPLICATIONS

This application is a by-pass continuation of International Application No. PCT/KR2023/021732, filed on Dec. 27, 2023, which is based on and claims priority to Korean Patent Application No. 10-2022-0190617, filed on Dec. 30, 2022, and Korean Patent Application No. 10-2023-0011991, filed on Jan. 30, 2023, in the Korean Intellectual Property Office, the disclosures of which are incorporated by reference herein in their entireties.

### BACKGROUND

### 1. Field

The disclosure relates to a method for providing haptics technology based on haptic content and an electronic device supporting the same.

### 2. Description of Related Art

With the development of digital technology, various types of electronic devices such as mobile communication terminals, personal digital assistants (PDAs), electronic notebooks, smartphones, tablets, personal computers (PCs), wearable devices, and/or laptop PCs are being widely used. In order to support and increase the functions of such electronic devices, hardware and/or software parts of electronic devices are continuously being developed.

Electronic devices may provide various services (or functions) to satisfy various needs of users. Recently, electronic devices may support haptics technology that may provide haptic services (or haptic functions) to users. For example, haptics technology may refer to technology that supports users to feel tactile, force, and/or kinesthetic sensations by using electronic devices. For example, haptics technology may include technology that generates artificial stimulation necessary for users to feel tactile or kinesthetic sensations by using electronic devices and transmits them to users.

An electronic device may provide haptics technology through haptic content. For example, the electronic device may provide haptic feedback to the user by outputting vibrations according to haptic data (or vibration patterns) mapped to the haptic content.

Recently, various types of haptic drivers have been researched and developed to improve the limited user interface (UI)/user experience (UX) of electronic devices, and as a result, research on various haptics application technologies and haptic content for electronic devices is also underway. For example, haptic content may be designed to map a designated vibration pattern in response to the content, and may provide haptic feedback to the user by generating vibration according to the vibration pattern mapped to the content in response to a user input (e.g., a touch) to the haptic content.

However, the distribution of haptic content may be insufficient to date, and there is a problem in that different haptic feedback is provided for each electronic device for the same haptic content depending on the hardware characteristics of the vibration motor of the electronic device.

### SUMMARY

Provided are a method for supporting a haptic service based on haptic content and an electronic device supporting the same are provided.

Further, provided are a method for providing haptic content based on an index using a minimum unit vibration pattern and an electronic device supporting the same are provided.

Further still, provided are a method for providing high-quality haptic feedback of the same or similar quality to each electronic device by sharing content including vibration data corresponding to pattern identifier (ID) information of combinable minimum unit vibration patterns (e.g., basic patterns), placement of basic patterns, and additional information (e.g., scale, delay, and/or duration) is provided, and an electronic device supporting the same is provided.

The technical problems addressed in the disclosure are not limited to the technical problems mentioned above, and other technical problems not mentioned will be clearly understood by those skilled in the art to which the disclosure belongs from the following description.

According to an aspect of the disclosure, an electronic device includes: a haptic driver; memory storing instructions; and at least one processor operatively connected to the haptic driver and the memory, wherein the instructions, when executed by the at least one processor individually or collectively, cause the electronic device to: sense playback of haptic content by the electronic device; identify, in the haptic content, an index corresponding to a combination of minimum unit vibration patterns for haptic feedback; combine the minimum unit vibration patterns based on the index to generate vibration data for haptic content; and provide the haptic feedback based on the vibration data using the haptic driver.

The haptic content may include content and the index in a text format, the content may include at least one of an emoticon, an image, a sound, a video, or text, and the index may include vibration pattern information corresponding to a combination of individual indices of the minimum unit vibration patterns.

The index may include one or more of pattern identifier (ID) information, duration, scale, or delay of a vibration pattern capable of distinguishing minimum unit vibration pattern, and the vibration pattern information may include information indicating at least one of vibration intensity, vibration length, vibration speed, operating information, or a delay time to a next vibration pattern.

Each of the minimum unit vibration patterns may include a basic pattern that forms a vibration pattern defined to express an emotion corresponding to the haptic content.

The instructions, when executed by the at least one processor individually or collectively, may further cause the electronic device to: call an index corresponding to a vibration pattern configured in the haptic content from a designated memory when sensing playback of the haptic content; and reconstruct the vibration pattern based on the called index to provide the haptic feedback when playing back the haptic content.

The instructions, when executed by the at least one processor individually or collectively, may further cause the electronic device to combine minimum unit vibration patterns of a same type in response to an emotion represented by the content.

The instructions, when executed by the at least one processor individually or collectively, may further cause the electronic device to combine minimum unit vibration patterns of a different type in response to an emotion represented by the content.

The instructions, when executed by the at least one processor individually or collectively, may further cause the electronic device to: extract a designated feature point from the content; generate at least one individual index based on a minimum unit vibration pattern corresponding to the designated feature point; and generate a vibration pattern for haptic content based on a combination of the at least one individual index.

The instructions, when executed by the at least one processor individually or collectively, may further cause the electronic device to: extract, from the content, at least one designated feature point based on at least one of an object, a word, a string, a time, a place, or an occasion corresponding to user's emotion; recognize at least one emotion corresponding to the at least one designated feature point; and provide a vibration pattern and haptic content based on a combination of the at least one individual index of the minimum unit vibration pattern corresponding to the at least one emotion. The instructions, when executed by the at least one processor individually or collectively, may further cause the electronic device to, based on sharing the haptic content with an external device, transmit, to the external device, content including pattern identifier (ID) information of minimum unit vibration patterns capable of being combined, placement of minimum unit vibration patterns, and vibration data corresponding to additional information.

The instructions, when executed by the at least one processor individually or collectively, may further cause the electronic device to: receive haptic content from an external device; analyze an index included in the haptic content received from the external device; based on the received index, combine individual indices corresponding to pre-stored minimum unit vibration patterns; and play back the haptic feedback, through the haptic driver, using a vibration pattern corresponding to the combination of individual indices.

According to an aspect of the disclosure, a method of operating an electronic device includes: sensing playback of haptic content by the electronic device; identifying, in the haptic content, an index corresponding to a combination of minimum unit vibration patterns for haptic feedback; combining the minimum unit vibration patterns based on the index to generate vibration data for haptic content; and providing the haptic feedback based on the vibration data using a haptic driver of the electronic device.

The haptic content may include content and the index in a text format, the content may include at least one of an emoticon, an image, a sound source, a video, or text capable of being output by the electronic device, the index may include vibration pattern information corresponding to a combination of individual indices of the minimum unit vibration patterns, and each of the minimum unit vibration patterns may include a basic pattern that forms a vibration pattern defined to express an emotion corresponding to the content.

The index may include at least one of pattern identification (ID) information, duration, scale, or delay of a vibration pattern capable of distinguishing minimum unit vibration patterns, and the vibration pattern information may include information indicating at least one of vibration intensity, vibration length, vibration speed, operating information, or a delay time to a next vibration pattern.

The method may further include: calling an index corresponding to a vibration pattern configured in the haptic content from a designated memory when sensing playback of the haptic content; and reconstructing the vibration pattern based on the called index to provide the haptic feedback when playing back the haptic content.

According to an aspect of the disclosure, a non-transitory computer-readable medium has instructions stored thereon, which when executed by at least one processor of an electronic device, cause the at least one processor to execute a method of operating the electronic device, the method including: sensing playback of haptic content by the electronic device; identifying, in the haptic content, an index corresponding to a combination of minimum unit vibration patterns for haptic feedback; combining the minimum unit vibration patterns based on the index to generate vibration data for haptic content; and providing the haptic feedback based on the vibration data using a haptic driver of the electronic device.

According to an electronic device, an operation method thereof, and a recording medium according to an embodiment of the disclosure, by reconstructing combinable haptic content based on an index, it is possible to provide haptic feedback with the same or similar high quality for each electronic device for haptic content. According to an embodiment, by including a text-format index (e.g., vibration pattern information) corresponding to a minimum unit vibration pattern (e.g., basic pattern) in the content and transmitting the same, the size (e.g., transmission capacity) of the haptic content may be reduced (e.g., lightened). According to an embodiment, the types of content for implementing haptic content may not be limited, and through this, it may contribute to the activation of a haptic service by more diverse and numerous haptic content.

Further scope of applicability of the disclosure will become apparent from the detailed description below. However, since various changes and modifications within the spirit and scope of the disclosure may be understood by those skilled in the art, specific embodiments such as detailed descriptions below should be understood as examples only.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram illustrating an example electronic device in a network environment according to various embodiments;

FIG. 2 is a diagram illustrating an example of supporting a haptic service between electronic devices according to an embodiment of the disclosure;

FIG. 3 is a diagram illustrating an example of a structure of a platform architecture of an electronic device according to an embodiment of the disclosure;

FIG. 4 is a diagram schematically illustrating a configuration of an electronic device according to an embodiment of the disclosure;

FIG. 5 is a flowchart illustrating an operation method of an electronic device according to an embodiment of the disclosure;

FIG. 6 is a diagram illustrating an example of providing haptic content in an electronic device according to an embodiment of the disclosure;

FIG. 7 is a diagram illustrating an example of providing haptic content in an electronic device according to an embodiment of the disclosure;

FIG. 8 is a flowchart illustrating an operation method of an electronic device according to an embodiment of the disclosure;

FIG. 9 is a diagram illustrating an example of generating haptic content in an electronic device according to an embodiment of the disclosure;

FIG. 10 is a diagram illustrating an example of a vibration pattern that may be provided by an electronic device and a vibration pattern of a minimum unit thereof according to an embodiment of the disclosure;

FIGS. 11A and 11B are diagrams illustrating examples of vibration patterns that may be generated by a combination of minimum unit vibration patterns according to an embodiment of the disclosure;

FIG. 12 is a diagram illustrating an example of generating haptic content in an electronic device according to an embodiment of the disclosure;

FIG. 13 is a diagram illustrating an example of configuring haptic content in an electronic device according to an embodiment of the disclosure;

FIG. 14 is a diagram illustrating an example of generating haptic content in an electronic device according to an embodiment of the disclosure;

FIG. 15 is a diagram illustrating an example of generating haptic content in an electronic device according to an embodiment of the disclosure;

FIG. 16 is a diagram illustrating an example of generating haptic content in an electronic device according to an embodiment of the disclosure;

FIG. 17 is a diagram illustrating an example of an index corresponding to haptic content in an electronic device according to an embodiment of the disclosure;

FIG. 18 is a flowchart illustrating an operation method of an electronic device according to an embodiment of the disclosure;

FIG. 19 is a diagram illustrating an example of sharing haptic content between electronic devices according to an embodiment of the disclosure;

FIG. 20 is a flowchart illustrating an operation method of an electronic device according to an embodiment of the disclosure;

FIG. 21 is a diagram illustrating an example of sharing an index for haptic content between electronic devices according to an embodiment of the disclosure;

FIG. 22 is a diagram illustrating an example of generating haptic content in an electronic device according to an embodiment of the disclosure;

FIG. 23 is a diagram illustrating an example of playing back haptic content in an electronic device according to an embodiment of the disclosure;

FIG. 24 is a diagram illustrating an example of playing back haptic content in an electronic device according to an embodiment of the disclosure; and

FIG. 25 is a diagram illustrating an example of playing back haptic content in an electronic device according to an embodiment of the disclosure.

### DETAILED DESCRIPTION

In the following description, like reference numerals refer to like elements throughout the specification.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

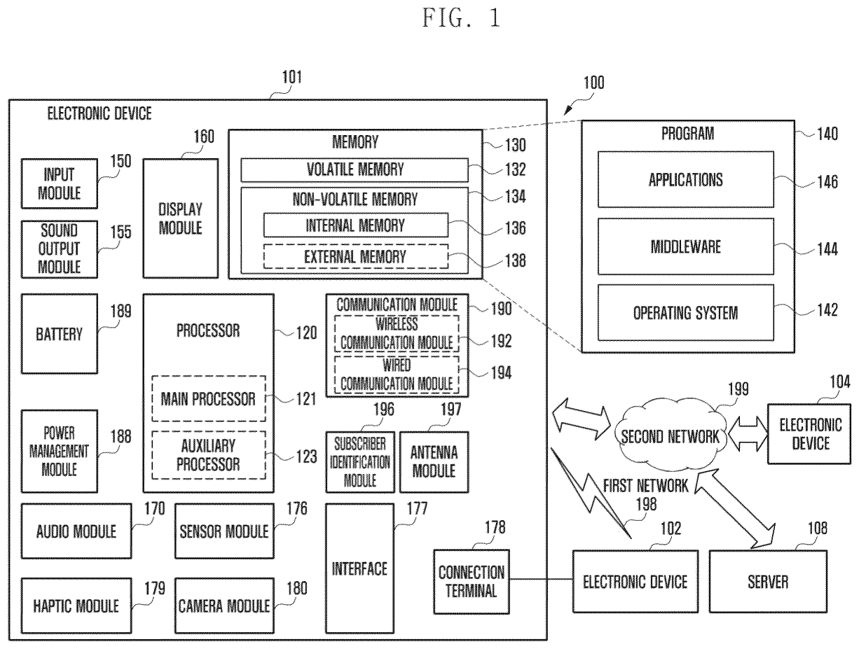

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

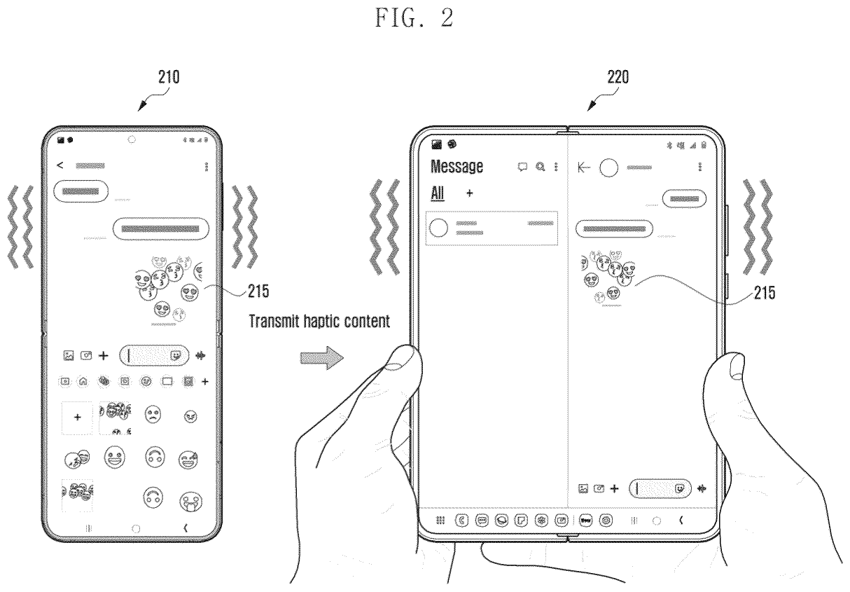

FIG. 2 is a diagram illustrating an example of supporting a haptic service between electronic devices according to an embodiment of the disclosure.

According to an embodiment, hereinafter, the electronic device 101 is described as an example of a portable terminal such as a smartphone, but the electronic device 101 according to an embodiment of the disclosure is not limited thereto. For example, it is apparent that the electronic device 101 according to the embodiment of the disclosure may be applied to all information and communication devices and multimedia devices such as a smartphone, a digital broadcast receiver, a personal digital assistant (PDA), a portable multimedia player (PMP), a notebook computer, a tablet personal computer (PC), and/or a wearable device (e.g., an AR device and/or a watch), and applications therefor.

Referring to FIG. 2, the system according to an embodiment may include a first electronic device 210 that outputs haptic feedback (or vibration) corresponding to haptic content based on a user input or shares (e.g., transmits) haptic feedback with another external electronic device (e.g., a second electronic device 220), and the second electronic device 220 that receives haptic content from the first electronic device 210 and outputs haptic feedback (or vibration) corresponding to the haptic content. According to an embodiment, the first electronic device 210 and the second electronic device 220 may correspond to the electronic device 101 as described in the description with reference to FIG. 1, or may include all or at least some of the components of the electronic device 101. According to an embodiment, the first electronic device 210 and the second electronic device 220 may be classified for understanding the disclosure, and the first electronic device 210 and the second electronic device 220 may perform the same configuration and operation.

Hereinafter, to describe an embodiment of the disclosure, the electronic device 101 that shares (e.g., transmits) haptic content is referred to as the first electronic device 210, and the electronic device 101 that receives haptic content shared from the first electronic device 210 and generates haptic feedback corresponding thereto is referred to as the second electronic device 220.

According to an embodiment, when a request for sharing haptic content 215 is provided by a user, the first electronic device 210 may identify content (e.g., content such as an emoticon, an image, a sound source, a video, and/or a text as a content source) constituting the haptic content 215 and at least one index (or vibration code, vibration index, or haptic data) capable of generating vibration with a vibration pattern designated through the content. According to an embodiment, the first electronic device 210 may transmit haptic content to the second electronic device 220 based on content corresponding to the haptic content 215 and at least one index. According to an embodiment, the first electronic device 210 may extract at least one index corresponding to pulse-code modulation (PCM) data (e.g., haptic data, original data, or wavelength data) rather than PCM data (e.g., entire vibration patterns) configured in the haptic content 215, convert the extracted at least one index and content of the haptic content 215 into a designated message format (e.g., a protocol or packet in a text format) and transmit the same to the second electronic device 220.

In an embodiment, PCM data may represent data converted from analog data to digital data. According to an embodiment, conventionally, fixed pattern (e.g., including a vibration pattern configuration information form that may be controlled by PCM or software) data for each content may be mapped and provided. An embodiment of the disclosure may map and provide an index using a minimum unit vibration pattern, thereby reducing (lightening) the size (capacity) of haptic content and providing various combinations of user-defined haptics based on at least one index.

According to an embodiment, a method of providing content and at least one index by distinguishing them based on haptic content 215 in the first electronic device 210 is described with reference to the drawings to be described below.

According to an embodiment, the second electronic device 220 may receive haptic content 215 transmitted from the first electronic device 210. According to an embodiment, the second electronic device 220 may receive content corresponding to the haptic content 215 and at least one index as the haptic content 215. According to an embodiment, the second electronic device 220 may extract the received content and index as the haptic content 215 based on a trigger (e.g., user input) displaying the received haptic content 215. According to an embodiment, the second electronic device 220 may configure (or combine) a vibration pattern (e.g., vibration magnitude (or level), pattern placement, scale, vibration length, and/or vibration delay) based on at least one index, and generate vibration (or vibration data, haptic data) for the haptic content 215 in response to the vibration pattern to provide haptic feedback to the user. According to an embodiment, elements constituting the vibration pattern are not limited to vibration magnitude, pattern placement, scale, vibration length, and/or vibration delay, but various elements capable of constituting the vibration pattern may be included.

According to an embodiment of the disclosure, haptic feedback based on the haptic content 215 in the first electronic device 210 and haptic feedback based on the haptic content 215 in the second electronic device 220 may be provided with the same or similar quality. For example, in the prior art, haptic drivers (e.g., motor drivers and vibration motors) for haptic feedback may be different for each electronic device. Therefore, in the prior art, haptic feedback may be provided differently depending on the electronic device, may be of poor quality, or may not be output if the vibration pattern of the haptic content is not implemented.

In an embodiment of the disclosure, when implementing haptic content in the electronic device 101, an index for a vibration pattern may be configured as a vibration pattern of the minimum unit of a vibration pattern constituting haptic content. Through this, when sharing haptic content, by sharing an index consisting of content for haptic content and a minimum unit vibration pattern instead of sharing haptic content to which the entirety of the existing PCM data is mapped, the size of the shared data (e.g., transmission data) may be reduced. For example, in the prior art, PCM data (e.g., haptic data) that matches the content must be included from the beginning to the end of the content, which has the disadvantage of increasing the size of haptic content in proportion to the length of the content, and additional costs (e.g., speed and/or charge) may be incurred when transmitting content between electronic devices as the size of the haptic content increases.

According to an embodiment of the disclosure, by providing an index based on a minimum unit vibration pattern, new various vibration patterns may be configured by a combination of indices, and reuse of haptic content by various vibration pattern configurations may be possible. According to an embodiment, the minimum unit vibration pattern (or basic haptic information) may represent a basic pattern that is an element that may combine vibration patterns, and the vibration pattern (e.g., haptic data) may include a combination of indices of the basic patterns.

According to an embodiment, as illustrated in FIG. 2, in the case that the first electronic device 210 shares the haptic content 215 (e.g., ambivalence emoticons) with the second electronic device 220 through a messenger application, when the haptic content 215 is played back in the first electronic device 210 and/or the second electronic device 220, an index corresponding to the haptic content 215 may be called, and a vibration pattern may be configured and played back based on the called index.

According to an embodiment, the system configuration illustrated in FIG. 2 is only an embodiment, and the system according to the disclosure may be applied to various applications based on the system configuration of FIG. 2. For example, the first electronic device 210 may operate to share the haptic content 215 with a plurality of other electronic devices according to an operation method for sharing the user's haptic content 215.

As described above, the electronic device 101 (e.g., the first electronic device 210 and/or the second electronic device 220) according to an embodiment of the disclosure may include a configuration for generating haptic content, a configuration for generating vibration corresponding to the haptic content, and a configuration for storing the haptic content. The configuration and operation of the electronic device 101 according to an embodiment of the disclosure will be described in more detail with reference to the drawings described below.

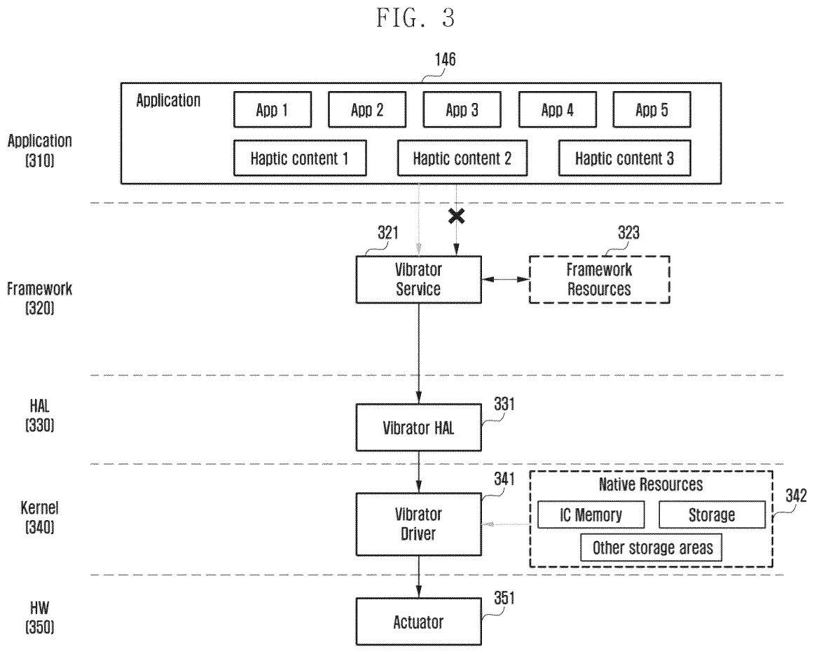

FIG. 3 is a diagram illustrating an example of a structure of a platform architecture of an electronic device according to an embodiment of the disclosure.

Referring to FIG. 3, the electronic device 101 according to an embodiment may support a haptic service (or haptic function or haptics technology) based on the structure of a platform architecture as illustrated in FIG. 3. According to an embodiment, the platform architecture of the electronic device 101 illustrated in FIG. 3 may be executed by the processor 120 and loaded into the memory 130 to be implemented in software.

For example, the configuration of the electronic device 101 implemented in software may be divided into an application layer 310 (e.g., the application 146 of FIG. 1), a framework layer 320 (e.g., the middleware 144 of FIG. 1), a hardware abstraction layer (HAL) 330, a kernel layer 340, and a hardware (HW) layer 350. According to an embodiment, at least a part of the configuration illustrated in FIG. 3 may be changed depending on the platform included in the electronic device 101. For example, at least a part of the platform architecture may be pre-loaded into the electronic device 101 during manufacturing, or downloaded or updated from an external electronic device (e.g., the electronic device 102 or 104 of FIG. 1 or server 108) when used by the user.

According to an embodiment, the application layer 310 may include an application (e.g., the application 146 of FIG. 1) and various content (e.g., haptic content).

According to an embodiment, the application 146 may draw at least one layer based on the resolution of the display area of the display module 160. In an embodiment, the application 146 may draw at least one layer based on the resolution of the display area of the display module 160 by using a drawing library (e.g., a view). The application 146 may include, but is not limited to, an application stored in the memory 130 of the electronic device 101 or executable or installed by the processor 120, for example, App 1, App 2, App 3, App 4, and/or App 5.

In an embodiment, the application 146 may include various applications executable in the electronic device 101. For example, the application 146 may include, but may not limited to, keypad (or keyboard), messenger, home, dialer, short message service (SMS)/multimedia messaging service (MMS), instant message (IM), browser, camera, alarm, contact, voice recognition, email, calendar, media player (e.g., sound source player, video player, text player), album, watch, health (e.g., measuring biometric information such as the amount of exercise or blood sugar), or environmental information (e.g., measuring air pressure, humidity, or temperature information) applications.

According to an embodiment, the application 146 may further include an information exchange application capable of supporting information exchange between the electronic device 101 and an external electronic device. The information exchange application may include, for example, a notification relay application configured to transmit designated information (e.g., data, call, message, or alarm) to the external electronic device, or a device management application configured to manage the external electronic device. According to an embodiment, the application 146 may include an air action application. The air action application may be an application that provides an interaction with a user for configuring an air action using an electronic pen (e.g., a stylus pen).

In an embodiment, the keypad may be an application that supports user input to the electronic device 101. For example, the keypad may generate various input signals necessary for the operation of the electronic device 101. According to an embodiment, the keypad may be displayed through the display module 160 and may provide a touch input and/or a hovering input (or proximity input) for a designated location of the keypad based on the touch circuit of the display module 160. For example, the display module 160 may further include a touch circuit. The touch circuit may include a touch sensor and a touch sensor IC for controlling the same. The touch sensor IC may control the touch sensor to sense, for example, a touch input or a hovering input for a designated location of the display. For example, the touch sensor IC may provide a signal (e.g., voltage, amount of light, resistance, or amount of charge) for a designated location of the keypad displayed through the display module 160 to the processor (e.g., the processor 120 of FIG. 1). According to an embodiment, the key map of the keypad may be displayed by changing at least a part thereof (e.g., at least one designated key button and/or key map structure itself) depending on the user's use of the keypad and/or a designated input.

According to an embodiment, the framework layer 320 (e.g., the middleware 144 of FIG. 1) may provide various functions to the application 146 so that functions or information provided from one or more resources (e.g., framework resources 323) of the electronic device 101 may be used by the application 146. The framework layer 320 may include, for example, a vibrator service 321, but is not limited thereto. For example, the framework layer 320 may include various managers, such as a window manager, a view system, an activity manager, a sensor manager, an application manager, a multimedia manager, a resource manager, a power manager, a database manager, a package manager, a connectivity manager, a notification manager, a location manager, a graphics manager, a security manager, a telephony manager, and/or a voice recognition manager.

According to an embodiment, the vibrator service 321 may apply the vibration intensity of the system configuration of the electronic device 101 that matches the usage to the vibration requested from the application 146 (or service). According to an embodiment, the vibrator service 321 may configure the requested vibration in a form suitable for an interface required by a lower layer of the system, and may serve to transmit the configured haptic data to the lower layer.

According to an embodiment, the framework resource 323 may represent an area for storing high-quality patterns that serve as a basis for generating new vibration patterns by combining multiple minimum unit vibration patterns. According to an embodiment, the framework resource 323 may have relatively less available memory constraints compared to the native resources 342 of the kernel layer 340.

According to an embodiment, the hardware abstraction layer (HAL) 330 is an abstracted layer between a plurality of hardware modules (e.g., the haptic module 179, the display module 160, the sensor module 176, the camera module 180, and/or the communication module 190 of FIG. 1) included in the hardware layer 350 and the software of the electronic device 101, and may include, but is not limited to, a vibrator HAL 331. For example, the hardware abstraction layer 330 may include an event hub and a surface flinger. The vibrator HAL 331 may provide an event (e.g., a vibration event) occurring in the vibrator service 321 to a vibrator driver 341. The event hub may be an interface that standardizes events occurring in a touch circuit (e.g., the display module 160) and a sensor circuit (e.g., the sensor module 176). The surface flinger may synthesize a plurality of layers, and may provide data representing the synthesized plurality of layers to a display controller. The display controller may refer to a graphic display controller.

According to an embodiment, the kernel layer 340 may include various drivers for controlling various hardware modules (e.g., the haptic module 179, the display module 160, the sensor module 176, the camera module 180, and/or the communication module 190 of FIG. 1) included in the electronic device 101. For example, the kernel layer 340 may include, but is not limited to, the vibrator driver 341 that controls the haptic module 179 (e.g., an actuator 351). For example, the kernel layer 340 may include a sensor driver including an interface module that controls a sensor controller connected to the sensor module 176 and a display controller (display driver IC (DDI)) that controls a display panel connected to the display module 160. According to an embodiment, the kernel layer 340 may include a native resource 342.

According to an embodiment, the vibrator driver 341 may convert the vibration pattern transmitted from the vibrator service 321 of the framework layer 320 into a form that is played back by an actual vibration motor (e.g., the actuator 351) or load, from the native resource 342, haptic data mapped to the index corresponding to the vibration pattern transmitted from the vibrator service 321 to control the driving of the actuator 351 in a playable form in the actual actuator 351. According to an embodiment, the native resource 342 may represent an area that stores basic high-quality patterns so that a new vibration pattern may be generated by combining multiple minimum unit vibration patterns. According to an embodiment, the native resource 342 has relatively limited available memory compared to the framework resource 323 of the framework layer 320, but may have an advantage in terms of performance. According to an embodiment, the native resource 342 may include, for example, IC memory, storage, and/or other storage areas.

According to an embodiment, the hardware layer 350 may include a hardware module or configuration (e.g., the actuator 351, a sensor controller, and/or a display panel) included in the electronic device 101, but is not limited thereto, and may include configurations illustrated in FIG. 1.

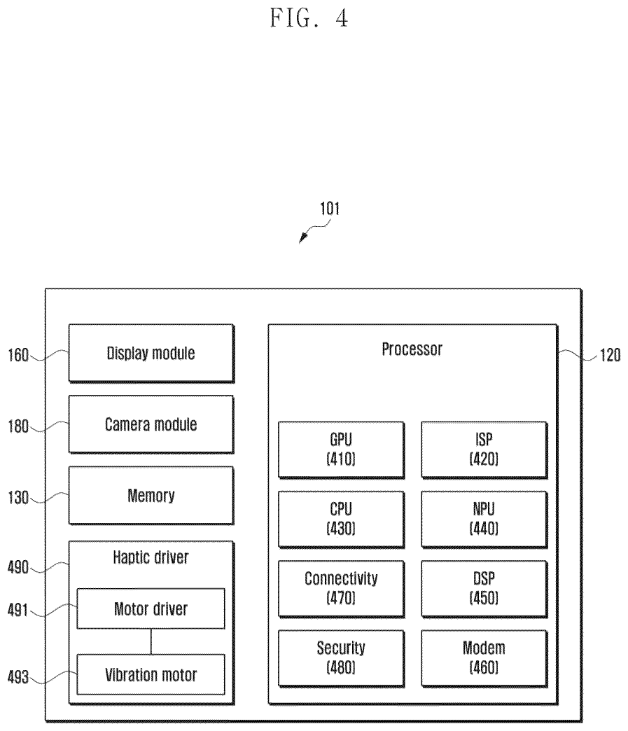

FIG. 4 is a diagram schematically illustrating a configuration of an electronic device according to an embodiment of the disclosure.

Referring to FIG. 4, the electronic device 101 (e.g., the first electronic device 210 and/or the second electronic device 220 of FIG. 2) according to an embodiment of the disclosure may include a display module 160 (e.g., the display module 160 of FIG. 1), a camera module 180 (e.g., the camera module 180 of FIG. 1), a memory 130 (e.g., the memory 130 of FIG. 1), a haptic driver 490 (e.g., the haptic module 179 of FIG. 1 or the actuator 351 of FIG. 2), and/or a processor 120 (e.g., the processor 120 of FIG. 1). According to an embodiment, the electronic device 101 may be the electronic device of FIG. 1, include at least some of the components of the electronic device 101 as described in the description with reference to FIG. 1, or may be additionally implemented by including other components.

According to an embodiment, the display module 160 may include the same or similar configuration as the display module 160 of FIG. 1. According to an embodiment, the display module 160 may include a display, and may visually provide various information to the outside (e.g., a user) of the electronic device 101 through the display. According to an embodiment, the display module 160 may visually provide various information (e.g., content, images, videos) related to an application to be executed under the control of the processor 120 and use of the application.

According to an embodiment, the display module 160 may include a touch sensor, a pressure sensor capable of measuring the intensity of a touch, and/or a touch panel (e.g., a digitizer) for detecting a magnetic field type stylus pen. According to an embodiment, the display module 160 may sense a touch input and/or a hovering input (or proximity input) by measuring a change in a signal (e.g., voltage, amount of light, resistance, electromagnetic signal and/or amount of charge) for a specific location of the display module 160 based on the touch sensor, the pressure sensor, and/or the touch panel. According to an embodiment, the display module 160 may include a liquid crystal display (LCD), an organic light emitting diode (OLED), and an active matrix organic light emitting diode (AMOLED). According to an embodiment, the display module 160 may include a flexible display.

According to an embodiment, the camera module 180 may correspond to the camera module 180 of FIG. 1 or FIG. 2. According to an embodiment, the camera module 180 may, when activated, capture a subject and transmit a related result (e.g., a captured image) to the processor 120 and/or the display module 160. According to an embodiment, the camera module 180 may photograph an external subject (or object) and generate image data. For example, the camera module 180 may include an image sensor. According to an embodiment, the camera module 180 may convert an optical signal of a subject into an electrical signal by the image sensor.

According to an embodiment, the memory 130 may correspond to the memory 130 of FIG. 1. According to an embodiment, the memory 130 may store various data used by the electronic device 101. In an embodiment, the data may include, for example, an application (e.g., the program 140 of FIG. 1), and input data or output data for a command related to the application. In an embodiment, the data may include various content (e.g., haptic content) for supporting the haptic service and various indices (or vibration code, vibration index, or haptic data). In an embodiment, the data (e.g., an index for a vibration pattern) may include various learning data obtained based on the user's learning through interaction with the user. In an embodiment, the data may include various schemas (or algorithms, models, networks, or functions) for supporting artificial intelligence (AI)-based haptic services.

According to an embodiment, the memory 130 may store an application (e.g., an application to support a haptic service) according to an embodiment required for a functional operation (e.g., a haptic service), and data (e.g., haptic content, content, index, image data, video data, and/or messages) generated by a user or received from the outside. According to an embodiment, the memory 130 may store various configuration information related to the haptic service. According to an embodiment, the memory 130 may include one or more buffers that temporarily store user data (e.g., vibration pattern for each haptic content (e.g., vibration magnitude (or level)), pattern placement, scale, vibration length, and/or vibration delay) generated during application execution. According to an embodiment, elements constituting the vibration pattern are not limited to vibration magnitude, pattern arrangement, scale, vibration length, and/or vibration delay, and various elements capable of constituting the vibration pattern may be included.

An example of user data according to an embodiment is illustrated in Table 1. According to an embodiment, the user data may be stored in the memory 130 of the electronic device 101 and/or an external device (e.g., an external storage device and/or a cloud server) in the form of a mapping table as illustrated in the example of Table 1. According to an embodiment, an index for a vibration pattern for each haptic content may be extracted and configured based on the mapping table as illustrated in Table 1, which will be described with reference to drawings to be described later.

TABLE 1

| | Vibration code | | Vibration | Vibration |
|---|---|---|---|---|
| Content | (or index) | Expression | magnitude | length |
| Content 1 | 0000 | Love | Long: weak- | Repeat |
| | | | weak-medium | 3 times |
| Content 2 | 0001 | Anger | Short: strong- | Repeat |
| | | | strong | 2 times |
| Content 3 | 0002 | Impression | Short: weak- | No repeat |
| | | | medium | |
| . . . | . . . | . . . | . . . | . . . |
| Content N | 0100 | Shouting | Long: weak- | Repeat |
| | | | medium | 4 times |

In an embodiment, Table 1 is an embodiment illustrated for convenience of description and understanding according to an embodiment of the disclosure, and the format of the mapping table of the disclosure is not limited to the format of Table 1, and the format of the mapping table may be combined in various forms. According to an embodiment, a mapping table such as the example of Table 1 may be arbitrarily added/modified by the user, or may be downloaded and updated from a server (e.g., a cloud server) (e.g., the server 108 of FIG. 1). According to an embodiment, new various vibration patterns may be configured through a merge of indices for each content combined based on the mapping table such as the example of Table 1. In an embodiment, the content may include content such as emoticons, images, sound sources, videos, and/or text (strings) as a content source for haptic content. According to an embodiment, the index (or vibration pattern information) for each content of the electronic device 101 may be converted into a designated message format, and the designated message format may be converted into the form of all packets (or messages) that may be generated by the electronic device (101) and/or a command signal. Therefore, the electronic device 101 may transmit the index for the vibration pattern to one or more other target electronic devices (e.g., the second electronic device 220 of FIG. 2).

According to an embodiment, the memory 130 may store instructions that, when executed individually or collectively, cause the processor 120 to operate. For example, an application may be stored as software (e.g., the program 140 of FIG. 1) in the memory 130, and may be executable by the processor 120. According to an embodiment, the application may be various applications capable of providing various functions or services (e.g., haptic services) in the electronic device 101.

According to an embodiment, the haptic driver 490 (e.g., the haptic module 179 of FIG. 1) may process a function for providing a haptic service (e.g., haptic feedback) under the control of the processor 120. According to an embodiment, the haptic driver 490 may include a motor driver 491 and a vibration motor 493.

According to an embodiment, the motor driver 491 may generate a constant voltage for driving the vibration motor 493. For example, the motor driver 491 may receive a control signal transmitted from the processor 120 according to a vibration pattern and generate a constant voltage for driving the vibration motor 493 in response to the control signal. According to an embodiment, the motor driver 491 changes the magnitude of the current applied to the vibration motor 493 according to the control signal of the processor 120 to change the vibration pattern/vibration level through gain control of the vibration motor 493, thereby generating various types of vibration.

According to an embodiment, the vibration motor 493 is driven by controlling the period and intensity according to the current control of the motor driver 491, and may generate vibration according to the corresponding vibration pattern/vibration level. According to an embodiment, the vibration motor 493 may include one or more vibration motors according to the type provided by the electronic device 101.

According to an embodiment, the processor 120 may perform an application layer processing required by the user of the electronic device 101. According to an embodiment, the processor 120 may provide control and commands of functions for various blocks of the electronic device 101. According to an embodiment, the processor 120 may perform an operation or data processing related to control and/or communication of each component of the electronic device 101. For example, the processor 120 may include at least some of the configuration and/or functions of the processor 120 of FIG. 1. According to an embodiment, the processor 120 may be operatively connected to the components of the electronic device 101. According to an embodiment, the processor 120 may load a command or data received from another component of the electronic device 101 into the memory 130, process the command or data stored in the memory 130, and store result data.

According to an embodiment, the processor 120 may be an application processor (AP). According to an embodiment, the processor 120 may be a system semiconductor responsible for an operation and a multimedia driving function of the electronic device 101. According to an embodiment, the processor 120 may include a technology-intensive semiconductor chip configured in the form of a system-on-chip (SoC) to integrate several semiconductor technologies into one and implement system blocks into one chip. According to an embodiment, as illustrated in FIG. 4, the system blocks of the processor 120 may include a graphics processing unit (GPU) 410, an image signal processor (ISP) 420, a central processing unit (CPU) 430, a neural processing unit (NPU) 440, a digital signal processor 450, a modem 460, a connectivity 470, and/or a security block 480.

According to an embodiment, the GPU 410 may be responsible for graphic processing. According to an embodiment, the GPU 410 may receive a command from the CPU 430 and perform graphic processing to express the shape, location, color, shade, movement, and/or texture of things (or objects) on a display.

According to an embodiment, the ISP 420 may be responsible for image processing and correction of an image and a video. According to an embodiment, the ISP 420 may correct unprocessed data (e.g., raw data) transmitted from the image sensor of the camera module 180 to generate an image in a form preferred by the user. According to an embodiment, the ISP 420 may correct physical limitations that may occur in the camera module 180, interpolate R/G/B (red, green, blue) values, and remove noise. According to an embodiment, the ISP 420 may perform post-processing such as adjusting partial brightness of an image and emphasizing a detailed part. For example, the ISP 420 may independently perform a quality tuning and correction process for an image obtained through the camera module 180 to generate a result preferred by the user. According to an embodiment, when providing a video through an artificial intelligence function, the ISP 420 may sense and display a human face, or adjust the brightness, focus, and/or color of the image by using the coordinates and information of the face.

According to an embodiment, the CPU 430 may play a role in corresponding to the processor 120. According to an embodiment, the CPU 430 may decipher a user's command, perform arithmetic and logical operations, and/or data processing. For example, the CPU 430 may be responsible for the function of memory, interpretation, operation, and control. According to an embodiment, the CPU 430 may control overall functions of the electronic device 101. For example, the CPU 430 may execute all software (e.g., applications) of the electronic device 101 on an operating system (OS) and control hardware devices.

According to an embodiment, the CPU 430 may include a single processor core or multiple processor cores. According to an embodiment, the CPU 430 may control the overall operation of the processor 120 to execute an application and perform neural network-based tasks required according to the execution of the application.

According to an embodiment, the NPU 440 may be responsible for the processing optimized for the deep-running algorithm of artificial intelligence. According to an embodiment, the NPU 440 is a processor optimized for deep-learning algorithm operations (e.g., artificial intelligence operations), which may process big data as quickly and efficiently as a human neural network. For example, the NPU 440 may be mainly used for artificial intelligence calculation. According to an embodiment, the NPU 440 may automatically adjust the focus by recognizing objects, environments, and/or people in the background when taking a video through the camera module 180, automatically switch the photographing mode of the camera module 180 to a food mode when taking a food photo, and/or erase only unnecessary subjects from the photographed result.

According to an embodiment, the electronic device 101 may support integrated machine learning processing through interaction between all processors such as the GPU 410, the ISP 420, the CPU 430, and the NPU 440.

According to an embodiment, the DSP 450 may represent an integrated circuit that helps process a digital signal quickly. According to an embodiment, the DSP 450 may perform a function of converting an analog signal into a digital signal and processing the same at high speed.

According to an embodiment, the modem 460 may perform a role that enables the use of various communication functions in the electronic device 101. For example, the modem 460 may support communication such as call and data transmission/reception while exchanging signals with the base station. According to an embodiment, the modem 460 may include an integrated modem (e.g., a cellular modem, an LTE modem, a 5G modem, a 5G-Advanced modem, and a 6G modem) that supports communication technologies such as LTE and 2G to 5G. According to an embodiment, the modem 460 may include an artificial intelligence modem to which an artificial intelligence algorithm is applied.

According to an embodiment, the connectivity 470 may support wireless data transmission based on IEEE 802.11. According to an embodiment, the connectivity 470 may support communication services based on IEEE 802.11 (e.g., Wi-Fi) and/or 802.15 (e.g., Bluetooth, ZigBee, UWB). For example, the connectivity 470 may use an unlicensed band to support communication services to an unspecified number of people in a local area such as indoors.

According to an embodiment, the security 480 may provide an independent security execution environment between data or services stored in the electronic device 101. According to an embodiment, the security 480 may play a role in preventing hacking from the outside through security on software and hardware in the process of user authentication when providing services such as biometric recognition, mobile ID, and/or payment of the electronic device 101. For example, the security 480 may provide an independent security execution environment for device security to enhance the security of the electronic device 101 itself and security services based on user information such as mobile ID, payment, and car keys in the electronic device 101.

According to an embodiment of the disclosure, the processor 120 may include a processing circuit and/or executable program elements. According to an embodiment, based on the processing circuit and/or executable program elements, the processor 120 may control (or process) an operation related to supporting a haptic service based on haptic content.

According to an embodiment, the processor 120 may sense playback of haptic content. According to an embodiment, the processor 120 may identify at least one index corresponding to a combination of minimum unit vibration patterns for haptic feedback in the haptic content. According to an embodiment, the processor 120 may combine the vibration patterns based on the at least one index to generate vibration data (or haptic data) for haptic content. According to an embodiment, the processor 120 may provide haptic feedback based on the vibration data (or haptic data). According to an embodiment, the processor 120 may process a designated operation based on the user input for the haptic content.

According to an embodiment, a detailed operation of the processor 120 of the electronic device 101 will be described with reference to drawings to be described below.

According to an embodiment, operations performed by the processor 120 may be implemented as a recording medium (or a computer program product). For example, the recording medium may include a non-transitory computer-readable recording medium in which a program for executing various operations (e.g., operations related to providing a haptic service) performed by the processor 120 is recorded.

The embodiments described in the disclosure may be implemented in a recording medium readable by a computer or a similar device by using software, hardware, or a combination thereof. According to a hardware implementation, the operations described in an embodiment may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or other electrical units for performing functions.

In an embodiment, a recording medium (or a computer program product) may include a computer-readable recording medium having recorded thereon a program for executing sensing playback of haptic content, identifying an index corresponding to a combination of minimum unit vibration patterns for haptic feedback in the haptic content, combining the vibration patterns based on the index to generate vibration data (or haptic data) for haptic content, and providing haptic feedback based on the vibration data (or haptic data).

The electronic device 101 according to an embodiment of the disclosure may include a display (e.g., the display module 160 of FIG. 1 or 4), a haptic driver (e.g., the haptic driver 490 of FIG. 4), a memory (e.g., the memory 130 of FIG. 1 or FIG. 4) that stores instructions, and at least one processor (e.g., the processor 120 of FIG. 1 or 4) operatively connected to the display, the haptic driver, and the memory.

According to an embodiment, the instructions, when executed by the processor 120, may cause the electronic device 101 to sense playback of haptic content. According to an embodiment, the instructions, when executed by the processor 120, may cause the electronic device 101 to identify an index corresponding to a combination of minimum unit vibration patterns for haptic feedback in the haptic content. According to an embodiment, the instructions, when executed by the processor 120, may cause the electronic device 101 to combine the vibration patterns based on the index to generate vibration data for haptic content. According to an embodiment, the instructions, when executed by the processor 120, may cause the electronic device 101 to provide haptic feedback based on the vibration data. According to an embodiment, the instructions, when executed by the processor 120, may cause the electronic device 101 to process a designated operation based on the user input for the haptic content.

According to an embodiment, the haptic content may include content and an index in a text format. According to an embodiment, the content may include all types of files such as an emoticon, an image, a sound source, a video, and/or text that are capable of being expressed in an electronic device. According to an embodiment, the index may include vibration pattern information corresponding to a combination of individual indices of the minimum unit vibration pattern.

According to an embodiment, the index may be configured in a text format including information on ID information, duration, scale, and/or delay of a pattern capable of distinguishing minimum unit vibration patterns.

According to an embodiment, the vibration pattern information may include information indicating a difference in vibration intensity, information indicating a difference in vibration length, information indicating a difference in vibration speed, operating information related to the vibration pattern, and/or information on delay time to the next vibration pattern.

According to an embodiment, the minimum unit vibration pattern may include a basic pattern that forms a vibration pattern defined to express the emotion corresponding to the content as vibration.

According to an embodiment, the instructions, when executed by the processor 120, may cause the electronic device 101 to call an index corresponding to the vibration pattern configured in the haptic content from a designated memory when sensing the playback of the haptic content.

According to an embodiment, the instructions, when executed by the processor 120, may cause the electronic device 101 to reconstruct a vibration pattern based on the called index to provide haptic feedback when playing back the haptic content.

According to an embodiment, the instructions, when executed by the processor 120, may cause the electronic device 101 to combine the same or different types of minimum unit vibration patterns in response to emotions expressed by content.

According to an embodiment, the instructions, when executed by the processor 120, may cause the electronic device 101 to extract a meaningful designated feature point from the content. According to an embodiment, the instructions, when executed by the processor 120, may cause the electronic device 101 to generate at least one individual index based on minimum unit vibration pattern corresponding to the extracted feature point. According to an embodiment, the instructions, when executed by the processor 120, may cause the electronic device 101 to generate a vibration pattern for haptic content based on a combination of at least one individual indices.

According to an embodiment, the instructions, when executed by the processor 120, may cause the electronic device 101 to extract at least one designated feature point based on at least one of meaningful object, word, string, and/or TPO (time, place, occasion) corresponding to the user's emotion from the content. According to an embodiment, the instructions, when executed by the processor 120, may cause the electronic device 101 to recognize at least one emotion corresponding to the at least one designated feature point. According to an embodiment, the instructions, when executed by the processor 120, may cause the electronic device 101 to provide a vibration pattern and haptic content for the vibration pattern based on a combination of at least one individual indices of the minimum unit vibration pattern corresponding to the at least one emotion.

According to an embodiment, the instructions, when executed by the processor 120, may cause the electronic device 101 to transmit, to an external device, content including ID information of minimum unit vibration patterns capable of being combined, placement of minimum unit vibration patterns, and vibration data corresponding to additional information when sharing the haptic content with the external device.

According to an embodiment, the instructions, when executed by the processor 120, may cause the electronic device 101 to receive haptic content from an external device. According to an embodiment, the instructions, when executed by the processor 120, may cause the electronic device 101 to analyze an index included in the haptic content. According to an embodiment, the instructions, when executed by the processor 120, may cause the electronic device 101 to combine each individual index corresponding to a pre-stored minimum unit vibration pattern based on the received index. According to an embodiment, the instructions, when executed by the processor 120, may cause the electronic device 101 to implement a vibration pattern corresponding to the combination of individual indices to play back haptic feedback.

Hereinafter, an operation method of the electronic device 101 according to one or more embodiments will be described in detail. Operations performed by the electronic device 101 according to one or more embodiments may be executed by the processor 120 including various processing circuits and/or executable program elements of the electronic device 101. According to an embodiment, operations performed by the electronic device 101 may be stored in the memory 130 and executed by instructions that, upon execution, cause the processor 120 to operate.

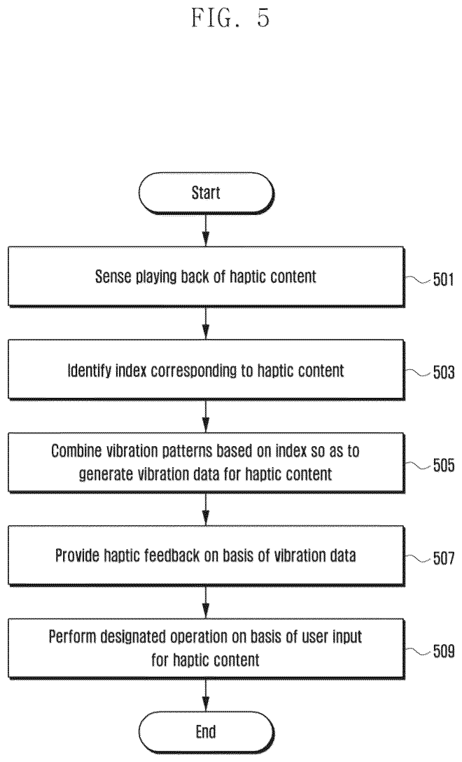

FIG. 5 is a flowchart illustrating an operation method of an electronic device according to an embodiment of the disclosure.

According to an embodiment, FIG. 5 may illustrate an example of an operation of providing a haptic service based on haptic content in the electronic device 101 according to an embodiment.

In the electronic device 101 according to an embodiment of the disclosure, a method of providing a haptic service based on haptic content may be performed according to, for example, the flowchart illustrated in FIG. 5. The flowchart illustrated in FIG. 5 is only a flowchart according to an embodiment of processing an operation related to supporting a haptic service in the electronic device 101, and the order of at least some operations may be changed or performed in parallel, performed as independent operations, or at least some other operations may be performed complementarily to at least some operations. According to an embodiment of the disclosure, operations 501 to 509 may be performed by at least one processor 120 of the electronic device 101.

As illustrated in FIG. 5, an operation method performed by the electronic device 101 according to an embodiment (e.g., an operation method for supporting a haptic service based on haptic content) may include an operation 501 for sensing the playback of haptic content, an operation 503 for identifying an index corresponding to the haptic content, an operation 505 for generating vibration data for the haptic content by combining vibration patterns based on the index, an operation 507 for providing haptic feedback based on the vibration data, and an operation 509 for performing the corresponding operation based on a user input for the haptic content.

Referring to FIG. 5, in operation 501, the processor 120 of the electronic device 101 may perform an operation of sensing playback of haptic content. According to an embodiment, the user may perform a user input (e.g., haptic content touch) for playback of haptic content displayed through the display (e.g., the display module 160 of FIG. 1 or FIG. 4) of the electronic device 101. According to an embodiment, the processor 120 may sense playback of haptic content based on sensing a user input based on haptic content. According to an embodiment, when sensing a user input (e.g., content playback) for the displayed content, the processor 120 may further perform an operation of determining whether the content corresponds to haptic content having vibration data (or haptic data). According to an embodiment, the processor 120 may determine that haptic content is being played back based on the fact that the content corresponding to the user input is haptic content.

In operation 503, the processor 120 may perform an operation of identifying an index corresponding to haptic content. According to an embodiment, the haptic content may consist of content and vibration data (or haptic data) corresponding to the content. According to an embodiment, the vibration data (or haptic data) may correspond to the entire PCM data mapped from the playback start point to the last (or end) point of the content, and may be composed of a combination of minimum unit vibration data (e.g., distinguished by an index). In an embodiment, the minimum unit vibration data may include a plurality of minimum unit vibration patterns and additional data such as additional information (e.g., scale, delay). In an embodiment, the minimum unit vibration data may indicate PCM data corresponding to one duty cycle that the user may distinguish by vibration, and may be distinguished by an index such as a vibration pattern name (e.g., pattern identifier) or a natural number (integer) (e.g., 1, 2, 3, . . . ).

According to an embodiment, when sensing playback of haptic content, the processor 120 may call at least one index constituting vibration data configured in the haptic content from the memory 130. According to an embodiment, the processor 120 may load (or call) an index in the area of the framework resource 323 of the framework layer 320 and/or the native resource 342 of the kernel layer 340 based on an application playing back haptic content. According to an embodiment, an example of the format of the minimum unit vibration data (e.g., the minimum unit vibration pattern) and additional information (e.g., scale, delay, etc.) constituting the vibration data of haptic content is disclosed in Table 2.

TABLE 2

```
key name = ”sticker_info”
data =
{
  ”sticker”: {
  ”sticker_info_version”: ”1.0.0”,
  ”type”: ”Sticker”,
  ”filename”: ”temp_file.png,
  ”packagename”: ”xxx.xxx.xxx.sticker”,
  ”tag”: { }
  ”haptic_pattern” : {
    {PRIMITIVE_CLICK, 1.0f, 75}, // happy
    {PRIMITIVE_TICK, 1.0f, 75}, // sad
    ...
  }
  }
}
```

As illustrated in Table 2, haptic content may include vibration data (or haptic data), and depending on the purpose and/or shape of the haptic content, the vibration data may include at least one index (or vibration pattern information or haptic data) corresponding to the minimum unit vibration pattern and additional information (e.g., scale, delay). According to an embodiment, assuming that the haptic content is an image file or emoticon (e.g., “sticker”) with vibration data, as in the example in Table 2, the entire vibration patterns (e.g., “haptic_pattern”) corresponding to the vibration data of the haptic content may be composed of minimum unit vibration patterns (e.g., “pattern 1”, “pattern 2”, . . . “pattern N”), and the minimum unit vibration patterns may include, for example, referring to Table 2, at least one first minimum unit vibration pattern designated to represent “happy” and at least one second minimum unit vibration pattern designated to represent “sad”.

According to an embodiment, the minimum unit vibration patterns may be repeatedly combined with the same minimum unit vibration pattern for each minimum unit vibration pattern, may have various scales according to the shape and/or purpose of the vibration pattern, and a delay may be configured for each minimum unit vibration pattern. According to an embodiment, the index may indicate an identifier (e.g., a pattern identifier (ID)) capable of distinguishing minimum unit vibration patterns. According to an embodiment, the scale and the delay may indicate additional information. For example, the minimum unit vibration data constituting the vibration data of haptic content may include the minimum unit vibration pattern and additional information, and the minimum unit vibration data may be distinguished by an index.

According to an embodiment, the minimum unit vibration data may include textualized vibration pattern information including an index and additional information. According to an embodiment, the minimum unit vibration data may be stored in a designated memory 130 (e.g., the framework resource 323 of the framework layer 320 and/or the native resource 342 of the kernel layer 340). For example, in Table 2, “{PRIMITIVE_CLICK, 1.0f, 75}, // happy” may represent one of various minimum unit vibration patterns (e.g., “pattern 1”) constituting the entire vibration patterns of content (e.g., “sticker”) for haptic content. According to an embodiment, a new vibration pattern may be provided by a combination of indices.

According to an embodiment, vibration pattern information constituting the index may include different information according to the intensity of the vibration, the length of the vibration, a difference in the speed of the vibration, an operation related to the vibration pattern, and/or a delay time to the next vibration pattern for the same minimum unit vibration pattern. For example, the vibration pattern information may include information indicating differences in the intensity of the vibration (e.g., light, medium, heavy), information indicating a difference in the length of the vibration (e.g., brief, short, medium, long, very long), and/or information indicating a difference in the speed of the vibration (e.g., slow, medium, quick). According to an embodiment, the vibration pattern information may include various operating information related to the vibration pattern. For example, the operating information may include a category, a design type, and/or usage details.

In an embodiment, the category may include “system” indicating a pattern used by the system, “alert” indicating a pattern provided by a phone ring/notification, and/or “effect” indicating any pattern other than “system” (e.g., active interaction feedback and other effects). In an embodiment, the design type may include “tick” indicating fine and concise haptic feedback (e.g., about 5 ms to about 10 ms), “click” indicating concise haptic feedback (e.g., vibration corresponding to heavy click or double click of about 10 ms to about 20 ms), and/or “buzz” indicating simple on/off haptic feedback (e.g., simple vibration of about 50 ms or longer). In an embodiment, the usage details may include an additional description of a specific operation or pattern.

According to an embodiment of the disclosure, new various vibration patterns may be generated and reused by variously combining indices corresponding to a plurality of minimum unit vibration patterns. According to an embodiment, various combinations of vibration patterns may be generated depending on how the minimum unit vibration patterns are combined. According to an embodiment, the size of haptic content may be reduced by mapping indices of high-quality vibration patterns produced in minimum units to content.

According to an embodiment, the electronic device 101 may have different vibration motors depending on the manufacturing method of the electronic device 101, and in the existing electronic device, different haptic feedback may be provided depending on the hardware characteristics of the vibration motor for the same vibration pattern, or haptic feedback may not be provided when the corresponding vibration pattern cannot be implemented by the vibration motor. According to an embodiment of the disclosure, by configuring the vibration pattern based on the index for each minimum unit vibration pattern regardless of the type of the vibration motor in the electronic device 101, the same or similar haptic feedback may be provided based on the same or substantially similar vibration pattern for the same haptic content for each electronic device.

In operation 505, the processor 120 may perform an operation of generating vibration data for haptic content by combining vibration patterns based on indices. According to an embodiment, the processor 120 may repeatedly combine the minimum unit vibration patterns “pattern 1” and “pattern 2” based on the index to configure vibration data, and map the vibration data to the content.

In operation 507, processor 120 may perform an operation of providing haptic feedback based on the vibration data. According to an embodiment, the processor 120 may play back haptic content. According to an embodiment, the processor 120 may play back (or output) a vibration corresponding to the configured vibration data based on a user input of selecting haptic content in an application.

In operation 509, the processor 120 may perform a designated operation based on a user input for haptic content. According to an embodiment, the processor 120 may perform an operation of sharing the haptic content based on the content and the index with an external device (e.g., a user account-based cloud server and/or another electronic device) corresponding to a user input for sharing haptic content. According to an embodiment, the processor 120 may perform an operation of registering an index (or vibration pattern information or haptic data) related to the vibration pattern of the haptic content in the cloud server by a user request.

According to an embodiment, the processor 120 may store haptic content in which the configured vibration data (e.g., PCM data) is mapped to the content based on the user request to generate (or store) the haptic content in the memory 130. For example, the processor 120 may perform an operation of mapping the vibration pattern configured based on an index into the corresponding content as PCM data to generate haptic content and storing the generated haptic content in the memory 130. According to an embodiment, the processor 120 may operate to provide haptic feedback by reconfiguring index-based vibration data each time when playing back haptic content, or to provide haptic feedback based on PCM data corresponding to the haptic content.

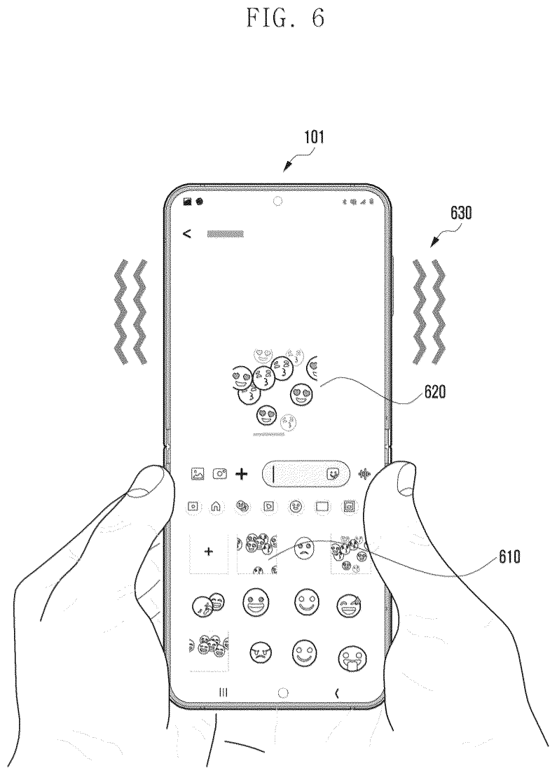

FIG. 6 is a diagram illustrating an example of providing haptic content in an electronic device according to an embodiment of the disclosure.

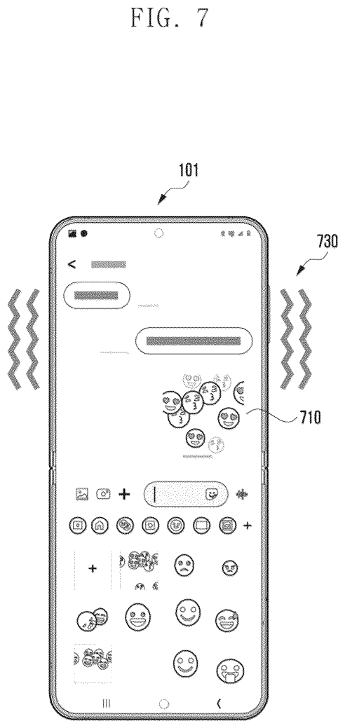

FIG. 7 is a diagram illustrating an example of providing haptic content in an electronic device according to an embodiment of the disclosure.

Referring to FIG. 6, the electronic device 101 may execute an application (e.g., a messenger application) corresponding to a user request and display the execution screen of the application on a display (e.g., the display module 160 of FIG. 1). According to an embodiment, the user may select haptic content 610 (e.g., an ambivalent emoticon) in the application to transmit the haptic content 610 to another designated electronic device. The electronic device 101 may display a shared object 620 (e.g., an object corresponding to a thumbnail image, an icon, and/or an emoticon) of the haptic content 610 corresponding to the user selection on the execution screen (e.g., a transmission standby field) of the application.

According to an embodiment, the electronic device 101 may play back vibration data corresponding to the haptic content 610 in response to a user input (e.g., touch) based on the haptic content 610 and/or a user input (e.g., touch) based on the shared object 620. According to an embodiment, the electronic device 101 may call an index mapped to the haptic content 610 and generate vibration data for haptic content by combining vibration patterns based on the index. According to an embodiment, the electronic device 101 may generate vibration according to the vibration data to provide a haptic feedback 630 to the user. According to an embodiment, the electronic device 101 may configure entire vibration patterns (or vibration data) based on the index for each minimum unit vibration pattern, and implement vibration based on the entire vibration patterns to provide the haptic feedback 630 to the user.

According to an embodiment, the electronic device 101 may share (e.g., transmit) the haptic content 610 selected based on the user input in the application to another electronic device. According to an embodiment, the electronic device 101 may select at least one haptic content 610 based on the user input as illustrated in FIG. 6, and share (e.g., transmit) at least one haptic content 610 with another designated electronic device based on an object (e.g., a transmit button) for sharing (e.g., transmitting) execution while at least one shared object 620 corresponding to each of the selected at least one haptic content 610 is provided in the transmission standby field of the execution screen. According to an embodiment, in response to the user input based on the transmission button, the electronic device 101 may transmit haptic content corresponding to at least one shared object 620 included in the transmission standby field to another designated electronic device through a communication circuit (e.g., the communication module 190 of FIG. 1).

According to an embodiment, when transmitting the haptic content 610 of the electronic device 101, the electronic device 101 may transmit related data (or information) that may implement the entire vibration patterns of the content (e.g., an ambivalent emoticon) and the haptic content 610 to another electronic device. According to an embodiment, in the related data, the entire vibration data mapped to the content may be composed of a combination of minimum unit vibration patterns. For example, the minimum unit vibration pattern may include a form of textualizing index and additional information (e.g., scale, delay). For example, the electronic device 101 may transmit an index and additional information in the form of text instead of PCM data corresponding to the entire vibration patterns of the haptic content 610.

Referring to FIG. 7, FIG. 7 may illustrate an example screen when a user executes transmission of the haptic content 610 to another electronic device in a state similar to the example of FIG. 6. As illustrated in FIG. 7, a sharing object 710 indicating the haptic content 610 requested to be shared according to user selection may be displayed on the execution screen (e.g., a chat window) of the application. According to an embodiment, the electronic device 101 may play back vibration data corresponding to the haptic content 610 in response to the user input (e.g., a touch) based on the shared object 710. According to an embodiment, the electronic device 101 may call an index mapped to the haptic content 610 and generate vibration data by combining vibration patterns based on the index. According to an embodiment, the electronic device 101 may generate vibration according to vibration data to provide a haptic feedback 730 to the user.

According to an embodiment, the electronic device 101 may configure entire vibration patterns (or vibration data) corresponding to the haptic content 610 based on the index for each minimum unit vibration pattern, and may implement vibration based on the entire vibration patterns to provide haptic feedback 730 to the user. According to an embodiment, it is described in relation to providing haptic feedback by calling the combined index mapped to the haptic content 610 from another electronic device that receives the haptic content 610 with reference to drawings described below.

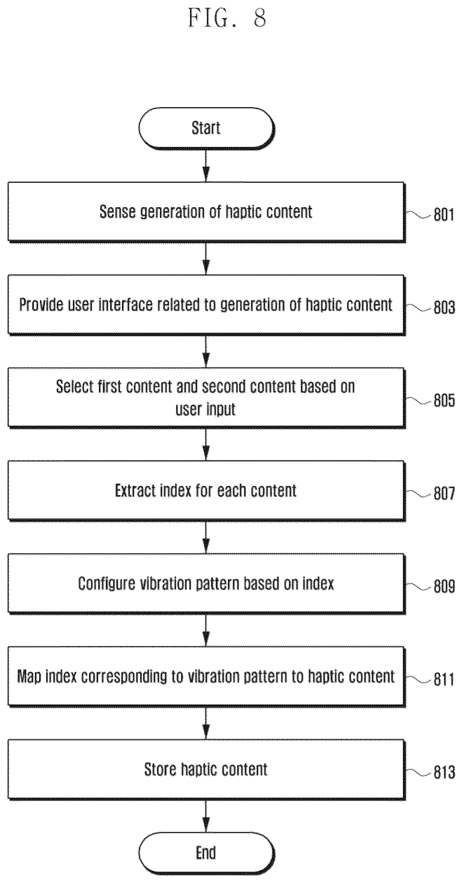

FIG. 8 is a flowchart illustrating an operation method of an electronic device according to an embodiment of the disclosure.

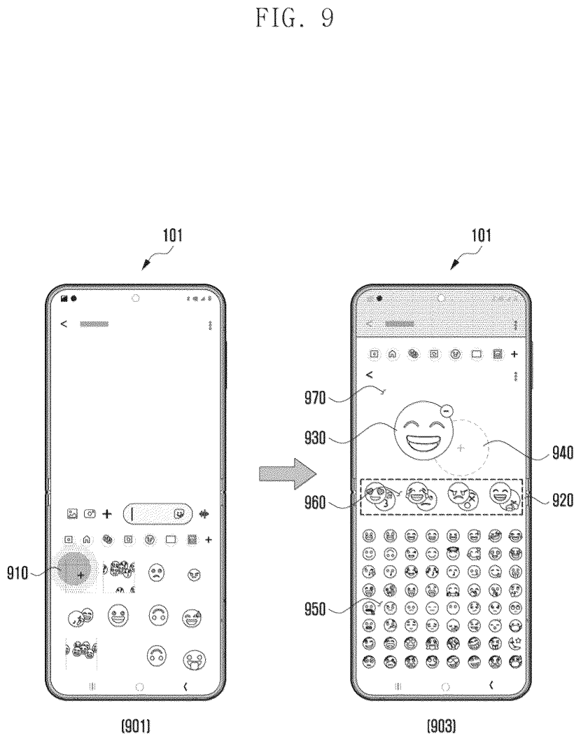

FIG. 9 is a diagram illustrating an example of generating haptic content in an electronic device according to an embodiment of the disclosure.

According to an embodiment, FIG. 8 may illustrate an example of an operation of providing a haptic service based on haptic content in the electronic device 101 according to an embodiment. For example, FIG. 8 may illustrate an example of an operation of generating haptic content based on an index combination.

In the electronic device 101 according to an embodiment of the disclosure, a method of providing a haptic service based on haptic content may be performed according to, for example, a flowchart illustrated in FIG. 8. The flowchart illustrated in FIG. 8 is only a flowchart according to an embodiment of processing an operation related to supporting a haptic service in the electronic device 101, and the order of at least some operations may be changed or performed in parallel, performed as independent operations, or at least some other operations may be performed complementarily to at least some operations. According to an embodiment of the disclosure, operations 801 to 813 may be performed by at least one processor 120 of the electronic device 101.

According to an embodiment, the operation described in FIG. 8 may be heuristically performed, for example, in combination with the operations described in FIGS. 5 to 7, or heuristically performed as a detailed operation of at least some of the described operations.

As illustrated in FIG. 8, an operation method performed by the electronic device 101 according to an embodiment (e.g., an operation method for supporting a haptic service based on haptic content) may include an operation 801 for sensing the generation of haptic content, an operation 803 for providing a user interface related to the generation of the haptic content, an operation 805 for selecting first content and second content based on a user input, an operation 807 for extracting an index for each content, an operation 809 for configuring a vibration pattern based on the index, an operation 811 for mapping an index corresponding to the vibration pattern to combined content, and an operation 813 for storing the haptic content.

Referring to FIG. 8, in operation 801, the processor 120 of the electronic device 101 may perform an operation of sensing generation of haptic content. According to an embodiment, the electronic device 101 may execute an application capable of generating (e.g., producing) haptic content based on a user input, and may perform a function of generating haptic content on the execution screen of the application. According to an embodiment, the processor 120 may sense the generation of the haptic content based on sensing the user input for selecting a function button (e.g., a production button) related to the generation of the haptic content on the execution screen of the application.

In operation 803, the processor 120 may perform an operation of providing a user interface related to the haptic content generation. According to an embodiment, the processor 120 may provide the user interface related to the haptic content generation through a display (e.g., the display module 160 of FIG. 1 or 4) on the execution screen of the application. An example of this is illustrated in FIG. 9.

Referring to FIG. 9, the example screen 901 may illustrate an example in which an execution screen (e.g., a user interface) related to the generation of haptic content is displayed. According to an embodiment, in FIG. 9, the content for haptic content is an emoticon, but is not limited thereto. For example, the content for haptic content may include any type of file that may be expressed in the electronic device 101, such as an image, text, sound source, and/or video. According to an embodiment, the user may generate haptic content based on selecting a function button 910 (e.g., a production button) on an execution screen such as the example screen 901.

According to an embodiment, the electronic device 101 may display an execution screen (e.g., a production user interface) capable of producing emoticon-based haptic content, such as an example screen 903, based on sensing a user input through the function button 910. According to an embodiment, a production user interface capable of producing emoticon-based haptic content may include a first area 950, a second area 960, and a third area 970.

According to an embodiment, the first area 950 may be configured (or stored) in the memory 130 of the electronic device 101 and may provide various emoticons (e.g., templates) indicating various emotions (or states) of the user. According to an embodiment, each of the various emoticons may be haptic content in which a vibration pattern capable of expressing a corresponding emotion (or state) as haptic feedback (e.g., vibration) is mapped in advance. According to an embodiment, the first area 950 may correspond to a keyboard area. For example, based on the user input for emoticon input in the keyboard area, a keyboard with a designated key map of the keyboard area may be switched into a list of emoticons.

According to an embodiment, the second area 960 may provide a pair emoticon 920. In an embodiment, the pair emoticon 920 may represent haptic content capable of expressing a strong emotion or an ambivalent emotion by combining at least two emoticons corresponding to the same emotion or different emotions, respectively. In an embodiment, the pair emoticon 920 may be haptic content previously produced by the user, and/or may be recommended haptic content that recommends a form that may be combined in the electronic device 101.

According to an embodiment, the third area 970 may be an area that guides a form in which at least two emoticons selected by the user to generate new haptic content are combined. According to an embodiment, the electronic device 101 may provide a pair emoticon in which at least two emoticons are combined through the third area 970 in response to an emoticon selected in response to the user input in the first area 950.

In operation 805, the processor 120 may perform an operation of selecting the first content and the second content based on the user input. According to an embodiment, the user may sequentially select (e.g., touch) the first content (e.g., the first emoticon representing the first emotion) and the second content (e.g., the second emoticon representing the second emotion) among the content (e.g., emoticons) displayed on the execution screen. An example thereof is illustrated in the example screen 903 of FIG. 9.

According to an embodiment, the example screen 903 may indicate a state in which a first emoticon 930 (e.g., a first content) representing a first emotion is selected by the user in the first area 950. According to an embodiment, the electronic device 101 may display the first emoticon 930 selected based on the first area 950 by the user on the third area 970. According to an embodiment, the electronic device 101 may provide an emoticon selected by the user to generate haptic content to the third area 970, and may guide whether a combinable emoticon may be added through a designated object 940 (e.g., an additional object).

In operation 807, the processor 120 may perform an operation of extracting an index for each content. According to an embodiment, the processor 120 may extract an index corresponding to each of the selected content based on completion of selecting all combinable content (e.g., emoticons) in parallel to operation 805 or to generate haptic content from the user by operation 805. For example, the processor 120 may extract, from the first content and the second content, a first index corresponding to the vibration pattern mapped to the first content and a second index corresponding to the vibration pattern mapped to the second content. For example, each content may have its own vibration pattern, and the processor 120 may extract an index corresponding to the unique vibration pattern of the content.

In operation 809, the processor 120 may perform an operation of configuring a new vibration pattern for new haptic content based on the index. According to an embodiment, the processor 120 may generate new haptic content (e.g., ambivalent content) in which the first content and the second content are combined based on a combination (or merge) of the first index and the second index, and generate a vibration pattern corresponding to the haptic content according to various combinations of the first index and the second index. In an embodiment, an example of a combination index of a combination of the first index and the second index and a vibration pattern corresponding thereto will be described with reference to drawings to be described below.

In operation 811, the processor 120 may perform an operation of mapping an index corresponding to the vibration pattern to the haptic content. According to an embodiment, the processor 120 may map a vibration pattern according to a combination index corresponding to the first content and the second content, respectively, to haptic content. According to an embodiment, when mapping the vibration pattern to haptic content, the processor 120 may map a combination index indicating PCM data (i.e., vibration pattern) rather than PCM data constituting the vibration pattern.

In operation 813, the processor 120 may perform an operation of storing haptic content. According to an embodiment, the processor 120 may map an index corresponding to the haptic content and store the mapped index as a look-up table. According to an embodiment, the processor 120 may configure and store PCM data of a vibration pattern in the haptic content. For example, when playing back haptic content, the processor 120 may provide haptic feedback by reconstructing the index-based vibration pattern each time, or may provide haptic feedback based on PCM data corresponding to the haptic content.

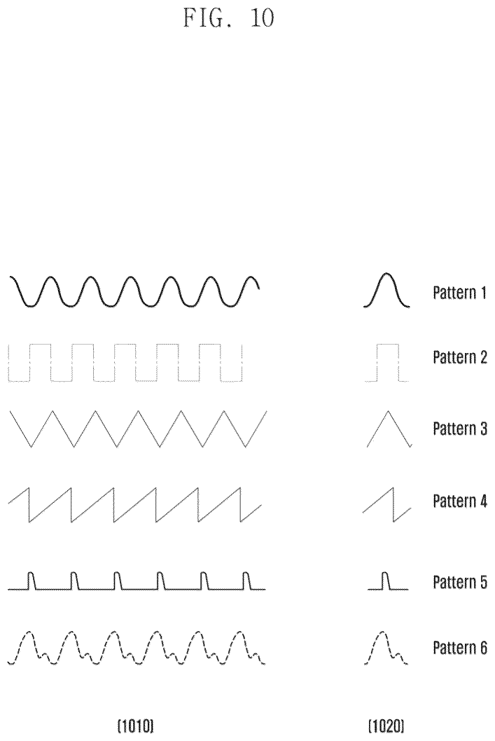

FIG. 10 is a diagram illustrating an example of a vibration pattern that may be provided by an electronic device and a vibration pattern of a minimum unit thereof according to an embodiment of the disclosure.

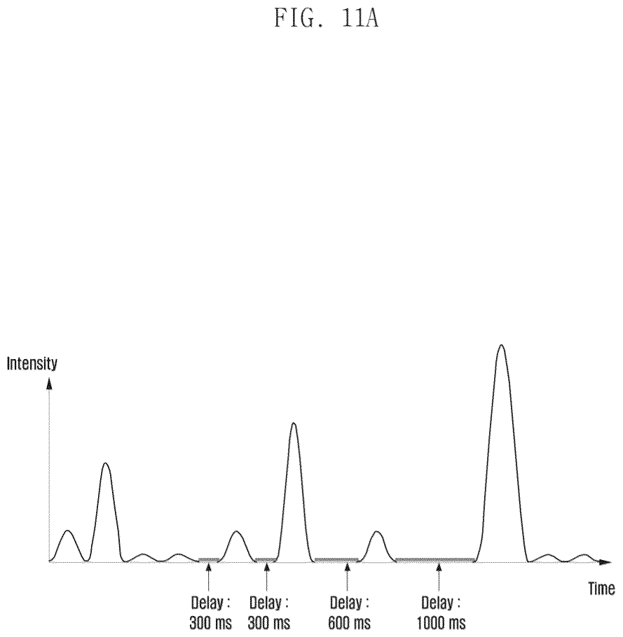

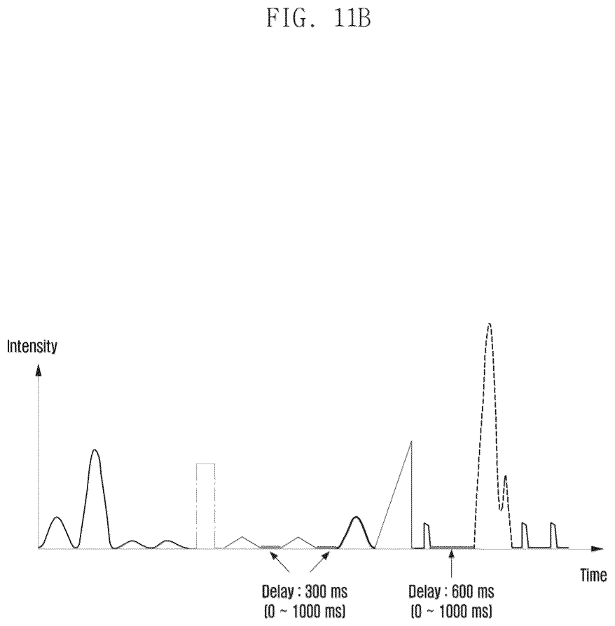

FIGS. 11A and 11B are diagrams illustrating examples of vibration patterns that may be generated by a combination of minimum unit vibration patterns according to an embodiment of the disclosure.

Referring to FIG. 10, the element 1010 may illustrate examples of various vibration patterns. For example, FIG. 10 illustrates an example of six vibration patterns 1010, but is not limited thereto, and the shape of the vibration patterns 1010 may be more diverse.

According to an embodiment of the disclosure, the element 1020 may illustrate an example of minimum unit vibration patterns. For example, the minimum unit vibration patterns 1020 may be defined based on at least a part of the vibration patterns 1010. According to an embodiment, the minimum unit vibration patterns 1020 may define six minimum unit vibration patterns (e.g., Pattern 1, Pattern 2, Pattern 3, Pattern 4, Pattern 5, and Pattern 6) corresponding to each of the six vibration patterns 1010, as illustrated in FIG. 10. According to an embodiment, in the case of the minimum unit vibration pattern 1020, in addition to the six vibration patterns according to the example of FIG. 10, more various minimum unit vibration patterns capable of covering all vibration patterns that nay be implemented in the electronic device 101 may be predefined in the electronic device 101.

According to an embodiment, the minimum unit vibration pattern may include a basic pattern that constitute a vibration pattern defined to express an emotion corresponding to the content through vibration. According to an embodiment, Pattern 1 to Pattern 6 may each be a part of each vibration pattern capable of expressing a corresponding emotion through designated content (e.g., content such as an emoticon, an image, a sound source, a video, and/or a text). For example, Pattern 1 may be a part of a vibration pattern that may express a first emotion through the designated content, and according to an embodiment, Pattern 2 may be a part of a vibration pattern that may express a second emotion through the designated content.

According to an embodiment of the disclosure, the electronic device 101 may configure a new type vibration pattern by combining at least two minimum unit vibration patterns. For example, the electronic device 101 may combine the vibration pattern of the first minimum unit (e.g., Pattern 1) and the vibration pattern of the second minimum unit (e.g., Pattern 2) to configure and store a new vibration pattern different from the above six vibration patterns 1010. According to an embodiment, examples of a vibration pattern defined based on a combination of minimum unit vibration patterns are illustrated in FIGS. 11A and 11B.

Referring to FIGS. 11A and 11B, in the illustrated drawings, the x-axis may represent a time axis, and the y-axis may represent the intensity (or level) of vibration. According to an embodiment, haptic content may have each unique vibration pattern and a minimum unit vibration pattern corresponding to the vibration pattern. According to an embodiment, a new vibration pattern may be provided according to various combinations based on the index of the minimum unit vibration pattern.

The example illustrated in FIG. 11A may represent an example of generating a vibration pattern by repeatedly combining one minimum unit vibration pattern. For example, FIG. 11A may illustrate an example of generating a vibration pattern by repeatedly combining Pattern 1 according to the example of FIG. 10. According to an embodiment, when repeatedly combining a minimum unit vibration pattern (e.g., Pattern 1), the electronic device 101 may configure the delay between the basic patterns of the minimum unit vibration pattern of Pattern 1 to be at least partially different (e.g., basic pattern variation), and may configure the scale (e.g., intensity) of the basic pattern to be at least partially different (e.g., basic pattern variation). For example, as illustrated in FIG. 11A, the basic pattern of Pattern 1 may be repeatedly combined, but additional information such as delay and scale may be configured at least partially differently (e.g., basic pattern variation) to generate a vibration pattern combined in a new form.

According to an embodiment, when generating a vibration pattern, the electronic device 101 may use an index corresponding to the basic pattern of the minimum unit vibration pattern to configure an individual index (or an independent index) corresponding to each pattern in which the basic pattern varies depending on the vibration pattern, and may configure a complete index corresponding to the vibration pattern based on a combination (or merge) of each individual indices. For example, the minimum unit vibration patterns may be repeatedly combined with the same minimum unit vibration pattern for each minimum unit vibration pattern, may have various scales depending on the shape and/or purpose of the vibration pattern, and the delay may be configured for each minimum unit vibration pattern.

According to an embodiment, the index may represent an identifier (e.g., a pattern identifier (ID)) that may distinguish a minimum unit vibration pattern. According to an embodiment, the scale and the delay may indicate additional information. For example, the minimum unit vibration data constituting the vibration data of haptic content may include a minimum unit vibration pattern and additional information, and the minimum unit vibration data may be distinguished by an index. According to an embodiment, the minimum unit vibration data may include textualized vibration pattern information including an index and additional information.

The example illustrated in FIG. 11B may represent an example of generating a vibration pattern by combining at least two different minimum unit vibration patterns. For example, FIG. 11B may illustrate an example of generating a vibration pattern by combining six patterns of Pattern 1, Pattern 2, Pattern 3, Pattern 4, Pattern 5, and Pattern 6 according to the example of FIG. 10. According to an embodiment, when selectively combining the minimum unit vibration patterns (e.g., Pattern 1 to Pattern 6), the electronic device 101 may configure the delay between each of the basic patterns to be at least partially different (e.g., basic pattern variation), and may configure the scale (e.g., intensity) of the basic pattern to be at least partially different (e.g., basic pattern variation). For example, as illustrated in FIG. 11B, a plurality of different types of basic patterns may be combined, but additional information such as delay and scale may be configured at least partially differently (e.g., basic pattern variation) to generate a vibration pattern combined in a new form.

According to an embodiment, when generating a vibration pattern, the electronic device 101 may use an index corresponding to the basic pattern of the minimum unit vibration pattern to configure an individual index (or an independent index) corresponding to each pattern in which the basic pattern varies depending on the vibration pattern, and may configure a complete index corresponding to the vibration pattern based on a combination (or merge) of each individual indices. For example, the minimum unit vibration patterns may be sequentially combined with the same or different types of minimum unit vibration patterns, may have various scales depending on the shape and/or purpose of the vibration pattern, and the delay may be configured for each minimum unit vibration pattern.

According to an embodiment, the index may represent an identifier (e.g., a pattern identifier (ID)) that may distinguish a minimum unit vibration pattern. According to an embodiment, the scale and the delay may represent additional information. For example, the minimum unit vibration data constituting the vibration data of haptic content may include a minimum unit vibration pattern and additional information, and the minimum unit vibration data may be distinguished by an index. According to an embodiment, the minimum unit vibration data may include textualized vibration pattern information including an index and additional information.

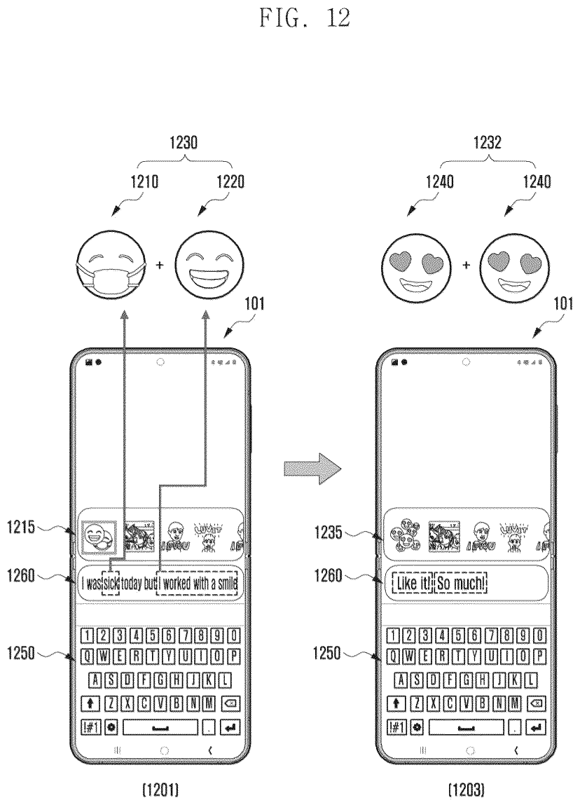

FIG. 12 is a diagram illustrating an example of generating haptic content in an electronic device according to an embodiment of the disclosure.

According to an embodiment, FIG. 12 may illustrate an example of an operation of generating haptic content based on a combination of indices in the electronic device 101 according to an embodiment.

According to an embodiment, while the user uses the application, based on a configuration related to automatic generation of haptic content, the electronic device 101 may extract a feature point corresponding to the minimum unit basic pattern from the content, generate at least one individual index corresponding to the extracted feature point, and automatically generate a vibration pattern for haptic content based on a combination of at least one individual indices.

According to an embodiment, while the user uses the electronic device 101, the electronic device 101 may support generation of haptic content in response to the user's request for generation of haptic content or automatic generation configuration. According to an embodiment, FIG. 12 may illustrate an example of extracting a feature point (e.g., text expressing emotions, emoticons, and/or facial objects in images) corresponding to an emotion based on content (e.g., text) input by a user and providing haptic content of ambivalent emotion based on the extracted feature point.

According to an embodiment, as illustrated in FIG. 12, a user may input a message (e.g., text) by using a keyboard 1250 (or keypad) on the execution screen of an application (e.g., a messenger application). The example screen 1201 and the example screen 1203 of FIG. 12 may each illustrate an example in which another message is input by the user. According to an embodiment, the electronic device 101 may display text corresponding to the user input on a designated area (e.g., a message input field 1260) based on the keyboard 1250. For example, a message input through the keyboard 1250 by the user may be displayed in the message input field 1260.

According to an embodiment, the electronic device 101 may extract a designated feature point (or content) based on a message (e.g., content) (e.g., a designated text expressing an emotion (e.g., a meaningful word or string)) input into the message input field 1260. For example, referring to the example screen 1201, the electronic device 101 may identify a first feature point (e.g., the text “I'm sick”) corresponding to a first emotion (e.g., pain) and a second feature point (e.g., the text “I'm smiling”) corresponding to a second emotion (e.g., joy and/or laughter) from a message (e.g., “I'm sick today, but I worked while smiling”). For example, referring to the example screen 1203, the electronic device 101 may identify a third feature point (e.g., the text “Like”) corresponding to a third emotion (e.g., liking) and a fourth feature point (e.g., the text “So much”) corresponding to the emotion emphasis from a message (e.g., “Like it! So much!”).

According to an embodiment, the electronic device 101 may provide various templates that are configured (or stored) in the memory 130 of the electronic device 101 and represent various emotions (or states) of the user. According to an embodiment, each of the various templates may be haptic content to which a vibration pattern capable of expressing a corresponding emotion (or state) as haptic feedback (e.g., vibration) is mapped in advance. According to an embodiment, the electronic device 101 may call an index of a minimum unit vibration pattern mapped to the designated feature point (or designated content) based on extracting a designated feature point from content (e.g., a message).

According to an embodiment, referring to the example screen 1201, the electronic device 101 may identify and call first content 1210 (e.g., emoticon, gif file, and/or emoji) mapped to express the first emotion and the corresponding minimum unit vibration pattern (e.g., Pattern 3 as exemplified in FIG. 10), and second content 1220 mapped to express the second emotion and the corresponding minimum unit vibration pattern (e.g., Pattern 1 as exemplified in FIG. 10). According to an embodiment, the electronic device 101 may provide new haptic content 1230 representing different emotions (e.g., ambivalent emotions) by associating (or combining) the first content 1210 corresponding to the first emotion and the second content 1220 corresponding to the second emotion.

For example, the electronic device 101 may provide a pair emoticon 1215 corresponding to the new haptic content 1230. In an embodiment, the pair emoticon 1215 may represent haptic content 1230 capable of expressing ambivalent emotions by combining at least two emoticons 1210 and 1220 respectively corresponding to different emotions (e.g., the first emotion and second emotion). In an embodiment, the pair emoticon 1215 may be haptic content previously produced by the user, and/or may be recommended haptic content that recommends a form that may be combined in the electronic device 101. In an embodiment, the pair emoticon 1215 may include various forms capable of expressing the first emotion 1210 and the second emotion 1220. For example, the pair emoticon 1215 may be provided in multiple forms based on a combination of emoticons, emojis, and/or gif file forms.

According to an embodiment, referring to the example screen 1203, the electronic device 101 may identify and call third content 1240 (e.g., emoticon, gif file, and/or emoji) mapped to express the third emotion and the corresponding minimum unit vibration pattern (e.g., Pattern 2 as exemplified in FIG. 10). According to an embodiment, the electronic device 101 may identify emotion emphasis emphasizing the third emotion. According to an embodiment, the electronic device 101 may provide new haptic content 1232 representing a strong emotion (e.g., a fourth emotion of strong liking) by associating (or combining) at least two third content 1240 corresponding to the third emotion based on the identification of the emotional emphasis.

For example, the electronic device 101 may provide a pair emoticon 1235 corresponding to the new haptic content 1232. In an embodiment, the pair emoticon 1235 may represent haptic content 1232 capable of expressing strong emotion by combining at least two emoticons 1240 corresponding to the same emotion (e.g., the third emotion). In an embodiment, the pair emoticon 1235 may be haptic content previously produced by the user, and/or may be recommended haptic content that recommends a form that may be combined in the electronic device 101. In an embodiment, the pair emoticon 1235 may include various forms capable of strongly expressing the third emotion 1230. For example, the pair emoticon 1235 may be provided in multiple forms based on a combination of emoticons, emojis, and/or gif file forms.

According to an embodiment, as illustrated in FIG. 12, the electronic device 101 may recognize a corresponding emotion index (e.g., individual index) based on a designated feature point (or designated content). According to an embodiment, the electronic device 101 may recognize, from first content and second content, a first index corresponding to the vibration pattern mapped to the first content and a second index corresponding to the vibration pattern mapped to the second content. For example, each content may have its own vibration pattern, and the electronic device 101 may extract an index corresponding to the unique vibration pattern of the content.

According to an embodiment, the electronic device 101 may configure a new vibration pattern for new haptic content based on an index. According to an embodiment, the electronic device 101 may generate new haptic content (e.g., ambivalent emotional content of the pair emoticon 1215 or strong emotional content of the pair emoticon 1235) in which the first content and the second content are combined based on the combination (or merge) of the first index and the second index, and generate a vibration pattern corresponding to the haptic content according to various combinations of the first index and the second index. In an embodiment, an example of a combination index of a combination of the first index and the second index and a vibration pattern corresponding thereto is illustrated in FIG. 11A or FIG. 11B described above. According to an embodiment, the electronic device 101 may recommend haptic content (e.g., ambivalent emotional content of the pair emoticon 1215 or strong emotional content of the pair emoticon 1235) generated based on the index combination to the user through a designated area.

According to an embodiment, the electronic device 101 may perform an operation of storing haptic content. According to an embodiment, the processor 120 may map an index corresponding to the haptic content and store the mapped index as a lookup table. According to an embodiment, the electronic device 101 may configure and store PCM data of a vibration pattern in the haptic content. For example, when playing back haptic content, the electronic device 101 may operate to provide haptic feedback by reconstructing the index-based vibration pattern each time, or to provide haptic feedback based on PCM data corresponding to the haptic content.

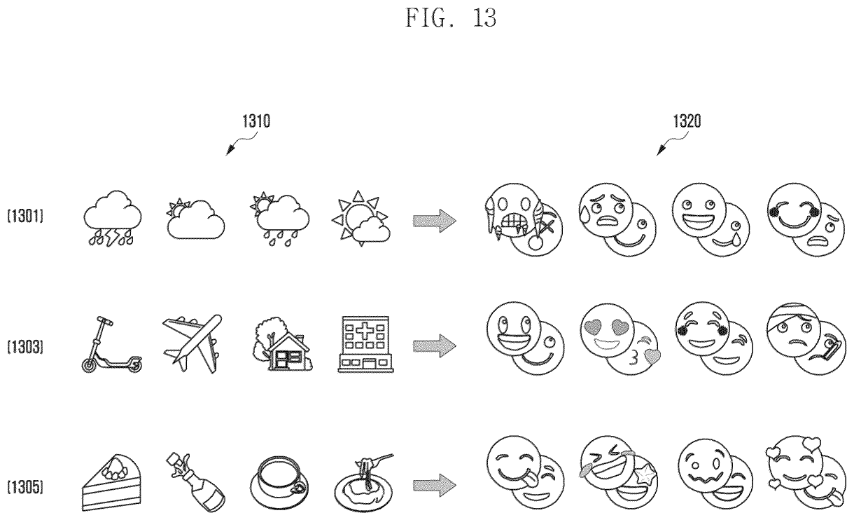

FIG. 13 is a diagram illustrating an example of configuring haptic content in an electronic device according to an embodiment of the disclosure.

According to an embodiment, FIG. 13 may illustrate various examples of haptic content capable of providing haptic feedback with vibrations corresponding to a vibration pattern designated for the same or different emotions in the electronic device 101. According to an embodiment, FIG. 13 may illustrate an example of recommending haptic content to a user in response to a designated category.

As illustrated in FIG. 13, the element area 1310 may represent an example of a category, and the element area 1320 may represent an example of haptic content that may be provided in a corresponding designated category.

According to an embodiment, the element 1301 may represent various examples of recommended haptic content respectively corresponding to subitems (e.g., rain, lightning, cloudy, snow, sunny, and/or at least two combinations thereof) of the first category in the first category (e.g., weather-based category). According to an embodiment, the electronic device 101 may recognize the user's environment (e.g., weather environment) based on a user input (e.g., inputting text related to weather (e.g., it's cold today, it's raining, etc.)). According to an embodiment, the electronic device 101 may recognize the user's environment (e.g., weather environment) based on a context-awareness technology. According to an embodiment, the electronic device 101 may provide recommended haptic content by extracting and combining at least two vibration patterns capable of expressing emotions according to the first category based on perception (e.g., environmental perception of the user according to the user input and/or context-awareness) corresponding to the first category. According to an embodiment, the electronic device 101 may provide recommended haptic content based on a combination of content (e.g., emoji, emoticon, or gif file) corresponding to at least two vibration patterns.

According to an embodiment, the element 1303 may represent various examples of recommended haptic content respectively corresponding to subitems (e.g., means of transportation (e.g., car, bicycle, airplane), place (e.g., home, travel destination, hospital, school, work)) of the second category in the second category (e.g., category based on travel (e.g., place (location) or means of transportation)). According to an embodiment, the electronic device 101 may recognize the user's environment (e.g., means of transportation and/or place) based on a user input (e.g., inputting text related to weather (e.g., travel (place) and text related to means of transportation (e.g., my flight to the US leaves tonight, I'm sick and on my way to the hospital, etc.)).

According to an embodiment, the electronic device 101 may recognize the user's environment (e.g., means of transportation and/or place) based on the context-awareness technology. According to an embodiment, the electronic device 101 may provide recommended haptic content by extracting and combining at least two vibration patterns capable of expressing emotions according to the second category based on perception (e.g., environmental perception of the user according to the user input and/or context-awareness) corresponding to the second category. According to an embodiment, the electronic device 101 may provide recommended haptic content based on a combination of content (e.g., emoji, emoticon, or gif file) corresponding to at least two vibration patterns.

According to an embodiment, the element 1305 may represent various examples of recommended haptic content respectively corresponding to subitems (e.g., food or food-related place) of the third category in the third category (e.g., food-based category). According to an embodiment, the electronic device 101 may recognize the user's environment (e.g., food consumption environment) based on the context-awareness technology and/or user input (e.g., input of food type or input of restaurant name). According to an embodiment, the electronic device 101 may provide recommended haptic content by extracting and combining at least two vibration patterns capable of expressing emotions according to the third category based on context-awareness and/or the user input corresponding to the third category. According to an embodiment, the electronic device 101 may provide recommended haptic content based on a combination of content (e.g., emoji, emoticon, or gif file) corresponding to at least two vibration patterns.

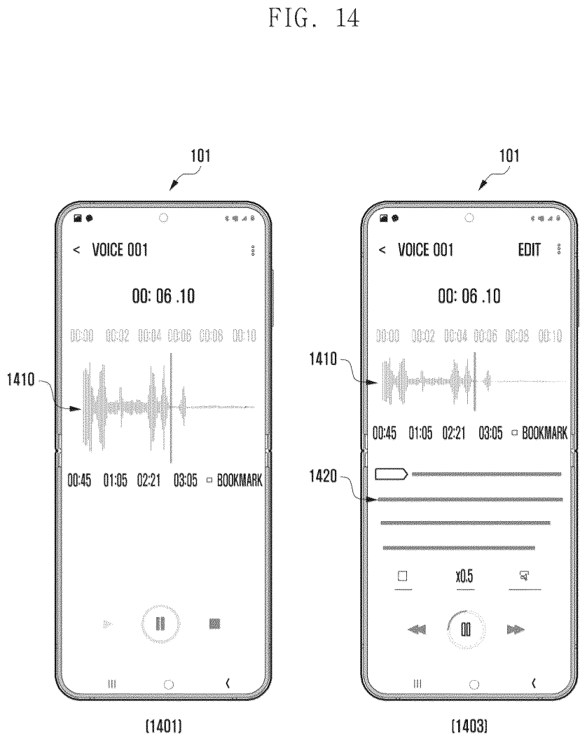

FIGS. 14, 15, and 16 are diagrams illustrating examples of generating haptic content in an electronic device according to an embodiment of the disclosure.

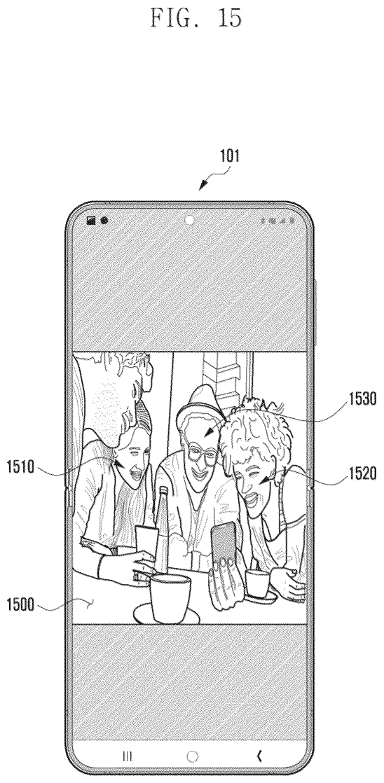

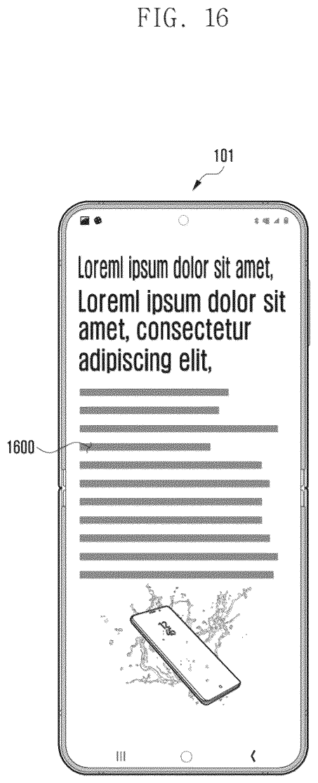

According to an embodiment, FIGS. 14, 15, and 16 may generate haptic content by combining indices with an operation corresponding to the above-described description with reference to FIG. 12. According to an embodiment, FIG. 12 may illustrate an example in which the type of content is text content, a corresponding individual index is generated based on the extraction of a designated feature point based on the text, and a vibration pattern is configured by a combination of the individual indices to provide haptic content. According to an embodiment, in the case where the types of content are, respectively, sound source (or audio) (e.g., music file, recording file) content (e.g., FIG. 14), image content (e.g., FIG. 15), and text (string) (e.g., FIG. 16), FIGS. 14, 15, and 16 may illustrate an example of generating a corresponding individual index based on the extraction of a designated feature point, and configuring a vibration pattern by a combination of individual indices to provide haptic content.

According to an embodiment, the operation of generating haptic content in FIGS. 14, 15, and 16 may correspond to the above-described description with reference to FIG. 12, and a detailed description thereof may be omitted.

According to an embodiment, FIG. 14 may illustrate an example of extracting a designated feature point based on a sound source being played back, and providing haptic content based on individual index combination corresponding thereto.

Referring to FIG. 14, an example screen 1401 and an example screen 1403 may represent an example of playing back a sound source file (e.g., VOICE 001) through a designated application (e.g., a media application) in the electronic device 101. According to an embodiment, the example screen 1401 may represent an interface example in a form of providing first playback information 1410 (e.g., audio waveform or sound waveform) in response to playback of a sound source file. According to an embodiment, the example screen 1403 may represent an interface example in a form of providing first playback information 1410 and second playback information 1420 (e.g., lyrics) together in response to playback of a sound source file. According to an embodiment, the electronic device 101 may play back a sound source file corresponding to a user request in an application (e.g., a media player).

According to an embodiment, as illustrated on the example screen 1401, the electronic device 101 may recognize (or extract) at least one designated feature point (e.g., a meaningful waveform among audio waveforms of the sound source file (e.g., a meaningful waveform based on sound source extraction (e.g., a waveform with relatively large amplitude and/or bits))) from the first playback information 1410 of the sound source file being played back. According to an embodiment, as illustrated on the example screen 1403, the electronic device 101 may recognize (or extract) at least one designated feature point (e.g., a meaningful word or string in the lyrics of a sound source file) from the second playback information 1420 of the sound source file being played back.

According to an embodiment, the electronic device 101 may perform the above operation for haptic generation automatically when playing back a sound source file or at least based on a user input (e.g., a designated input for haptic generation (e.g., a designated voice input, a designated object (e.g., button) selection)) in response to a configuration method of the electronic device 101.

According to an embodiment, the electronic device 101 may identify an index (e.g., individual index) of a minimum unit vibration pattern mapped to a designated feature point. According to an embodiment, the electronic device 101 may configure a vibration pattern for haptic content based on at least one individual index. According to an embodiment, the electronic device 101 may generate haptic content based on a combination (or merge) of at least one individual indices, and may generate a vibration pattern corresponding to the haptic content according to various combinations of at least one individual index.

According to an embodiment, FIG. 15 may illustrate an example of extracting a designated feature point based on a displayed image (e.g., a picture or video) and providing haptic content based on an individual index combination corresponding thereto.

Referring to FIG. 15, the electronic device 101 may display an image 1500 of an image file corresponding to a user request in an application (e.g., a gallery application). According to an embodiment, the electronic device 101 may recognize at least one designated feature point (e.g., face-specific emotion based on facial object recognition) in the displayed image 1500. According to an embodiment, the electronic device 101 may determine at least one subject 1510, 1520, and 1530 based on image information (e.g., a family photo) in the image, and determine a corresponding emotion based on facial object recognition when the subjects 1510, 1520, and 1530 are a specific object (e.g., a person). For example, the electronic device 101 may recognize various emotions or emotional changes from the facial object. Facial object-based emotion recognition may be performed by various techniques (e.g., learning by algorithm or AI model) related to facial emotion recognition. According to an embodiment, the electronic device 101 may recognize various emotions such as sadness, anger, fear, disgust, blank expression, surprise, enjoyment, joy, and/or laughter from the facial object.

According to an embodiment, the electronic device 101 may generate an emotion-specific vibration pattern corresponding to each facial object (e.g., 1510, 1520, 1530) in the image 1500. According to an embodiment, the electronic device 101 may identify an index (e.g., individual index) of a minimum unit vibration pattern mapped to a designated feature point. According to an embodiment, the electronic device 101 may configure a vibration pattern for haptic content based on at least one individual index. According to an embodiment, the electronic device 101 may generate haptic content based on a combination (or merge) of at least one individual index, and may generate a vibration pattern corresponding to the haptic content according to various combinations of at least one individual indices.

According to an embodiment, FIG. 16 may illustrate an example of extracting a designated feature point based on displayed text and providing haptic content based on a corresponding individual index combination.

Referring to FIG. 16, the electronic device 101 may display text 1600 according to the playback of an e-book file corresponding to a user request in an application (e.g., an e-book application or an audiobook). According to an embodiment, the electronic device 101 may recognize at least one designated feature point (e.g., a meaningful word or character string among the text 1600 of an e-book file) from the text 1600 being displayed in the e-book file being played back. According to an embodiment, the electronic device 101 may identify an index (e.g., individual index) of a minimum unit vibration pattern mapped to a designated feature point. According to an embodiment, the electronic device 101 may configure a vibration pattern for haptic content based on at least one individual index. According to an embodiment, the electronic device 101 may generate haptic content based on a combination (or merge) of at least one individual index, and may generate a vibration pattern corresponding to the haptic content according to various combinations of at least one individual indices.

According to an embodiment, as described in the description with reference to FIGS. 12, 14, 15, and/or 16, the electronic device 101 may extract (e.g., text extraction, optical character recognition (OCR) recognition, object recognition, and/or context-awareness) a meaningful designated feature point (e.g., meaningful waveform, object, word, string, TPO (e.g., time, place, occasion) corresponding to the user's emotion) from the given content and recognize an emotion corresponding thereto. According to an embodiment, the electronic device 101 may provide a vibration pattern and haptic content therefor based on a combination of at least one individual indices of a minimum unit vibration pattern (e.g., a basic pattern) corresponding to at least one recognized emotion.

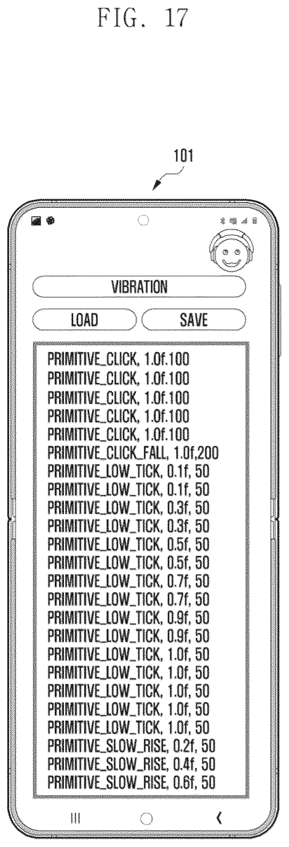

FIG. 17 is a diagram illustrating an example of an index corresponding to haptic content in an electronic device according to an embodiment of the disclosure.

According to an embodiment, FIG. 17 is a diagram illustrating an example of an index (e.g., vibration pattern information) mapped to haptic content. According to an embodiment, FIG. 17 may illustrate an example in which vibration pattern information (e.g., minimum unit vibration pattern) of haptic content is displayed on the electronic device 101 in a text format, as described in the description referring to Table 2.

According to an embodiment, the vibration pattern information of the haptic content may have a text format. For example, the text format may be configured as a text format such as “text format=(pattern_name, scale, delay)” as illustrated in FIG. 17. In an embodiment, “pattern_name” may indicate an index that distinguishes the type of the basic vibration pattern (e.g., “PRIMITIVE_CLICK, PRIMITIVE_QUICK_FALL, PRIMITIVE_LOW_TICK, PRIMITIVE_SLOW_RISE” as illustrated). In an embodiment, the index described as the pattern_name of the basic vibration pattern may also be expressed as a natural number (integer) (e.g., a number such as 1, 2, . . . 107). For example, each index may be provided by being replaced by a natural number, such as “PRIMITIVE_CLICK=1”, “PRIMITIVE_QUICK_FALL=2”, “PRIMITIVE_LOW_TICK=3”, “PRIMITIVE_SLOW_RISE=4” of “pattern_name”.

In an embodiment, the “scale” may represent a vibration intensity magnitude (or strength) (e.g., “1.0f, 0.1f, 0.3f”, etc., as illustrated), and the range of scale may include between about 0 and about 1.0. In an embodiment, “delay” may represent a delay (e.g., “50, 100, 200”, etc. as illustrated) until the next vibration pattern is played back, and may use millisecond units.

According to an embodiment, the electronic device 101 may provide vibration pattern information of a specific haptic content in a text format through the display (e.g., the display module 160 of FIG. 1 or 4) of the electronic device 101 based on a request for providing information on vibration pattern information for the specific haptic content by a user. According to an embodiment, the vibration pattern information of the haptic content may be configured in a text format as illustrated in Table 2 and FIG. 17. According to an embodiment, the vibration pattern of the haptic content may be shared (e.g., transmitted) with an external device (e.g., a user account-based cloud server and/or another electronic device) in a simple and small capacity through text format rather than PCM data. According to an embodiment, the electronic device 101 may transmit an index corresponding to the haptic content to an external device in a designated protocol format.

According to an embodiment, by configuring the vibration pattern of the haptic content in the electronic device 101 with a combination of indices of a text format based on a minimum unit vibration pattern instead of PCM data, haptic content may be provided based on various types of content such as all message formats, file formats, and/or streaming formats that may be supported by the electronic device 101. According to an embodiment, the electronic device 101 may provide haptic feedback identical to or similar to the vibration pattern implemented by the electronic device 101 even in an electronic device with different motor specifications from the electronic device 101 by reconstructing the entire vibration patterns for haptic content based on the vibration pattern information in a text format.

According to an embodiment, the electronic device 101 may not transmit PCM data (e.g., original data or wavelength data of a vibration pattern) corresponding to the haptic content as it is, but may transmit, for example, text-format vibration pattern information including an index of a pattern (e.g., ID information or ID value) that may distinguish the minimum unit basic vibration patterns and additional information on duration, scale, and/or delay by including the same in the content. Through this, according to an embodiment of the disclosure, information on the vibration pattern may be transmitted to an external device by using only a small capacity by the text-format index for the vibration pattern of the haptic content. According to an embodiment, another electronic device receiving an index from the electronic device 101 may play back the vibration pattern by combining the minimum unit basic vibration pattern (e.g., the basic pattern corresponding to the ID information of the pattern) stored in a separate storage space (e.g., the memory 130) according to the placement of the received index. Accordingly, even if another electronic device has a motor with different specifications from that of the electronic device 101, a vibration pattern may be implemented in the same manner as the electronic device 101, and the same haptic feedback may be provided for each electronic device.

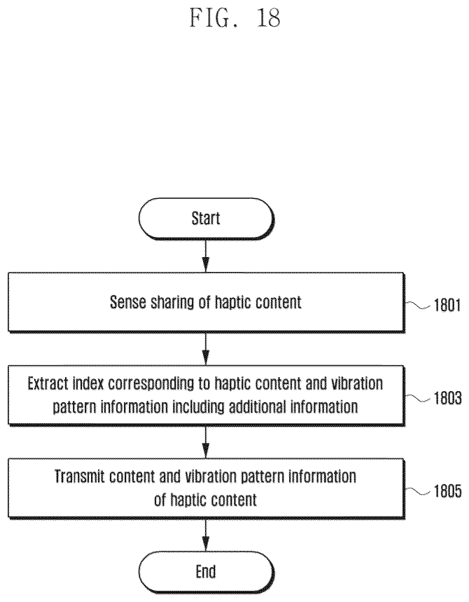

FIG. 18 is a flowchart illustrating an operation method of an electronic device according to an embodiment of the disclosure.

FIG. 18 may illustrate an example of an operation of providing a haptic service based on haptic content in the electronic device 101 according to an embodiment. According to an embodiment, FIG. 18 may illustrate an example of an operation in which the electronic device 101 shares (e.g., transmits) haptic content with an external device (e.g., a user account-based cloud server and/or another electronic device).

In the electronic device 101 according to an embodiment of the disclosure, a method for providing (e.g., transmitting) haptic content may be performed according to, for example, a flowchart illustrated in FIG. 18. The flowchart illustrated in FIG. 18 is only a flowchart according to an embodiment of processing an operation related to sharing haptic content in the electronic device 101, and the order of at least some operations may be changed or performed in parallel, performed as independent operations, or at least some other operations may be performed complementarily to at least some operations. According to an embodiment of the disclosure, operations 1801 to 1805 may be performed by at least one processor 120 of the electronic device 101.

According to an embodiment, the operation described in FIG. 18 may be heuristically performed, for example, in combination with the operations described in FIGS. 5 to 17, or may be heuristically performed as a detailed operation of at least some of the described operations.

As illustrated in FIG. 18, an operation method (e.g., an operation method for sharing haptic content) performed by the electronic device 101 according to an embodiment may include an operation 1801 of sensing sharing of haptic content, an operation 1803 of extracting an index corresponding to haptic content, and an operation 1805 of transmitting content and an index of haptic content.

Referring to FIG. 18, in operation 1801, the processor 120 of the electronic device 101 may perform an operation of sensing sharing of haptic content. According to an embodiment, the electronic device 101 may execute an application capable of sharing (e.g., transmitting) haptic content based on a user input, and may receive a user input for selecting haptic content to be shared on the execution screen of the application. According to an embodiment, the processor 120 may sense sharing of haptic content based on sensing a user input for selecting a function button (e.g., a transmission button) related to sharing of haptic content on the execution screen of the application.

In operation 1803, the processor 120 may perform an operation of extracting vibration pattern information (e.g., entire vibration patterns (or vibration data)) including an index corresponding to haptic content and additional information. According to an embodiment, the processor 120 may extract (e.g., call (or load) from the memory 130) vibration pattern information including an index corresponding to the selected haptic content and additional information.

In operation 1805, the processor 120 may perform an operation of transmitting content of haptic content and vibration pattern information. According to an embodiment, the processor 120 may perform an operation of sharing haptic content on an external device (e.g., a user account-based cloud server and/or another electronic device) corresponding to a user input based on content and vibration pattern information. According to an embodiment, the processor 120 may perform an operation of transmitting vibration pattern information or haptic data related to a vibration pattern of haptic content through a communication circuit (e.g., the communication module 190 of FIG. 1) by a user request.

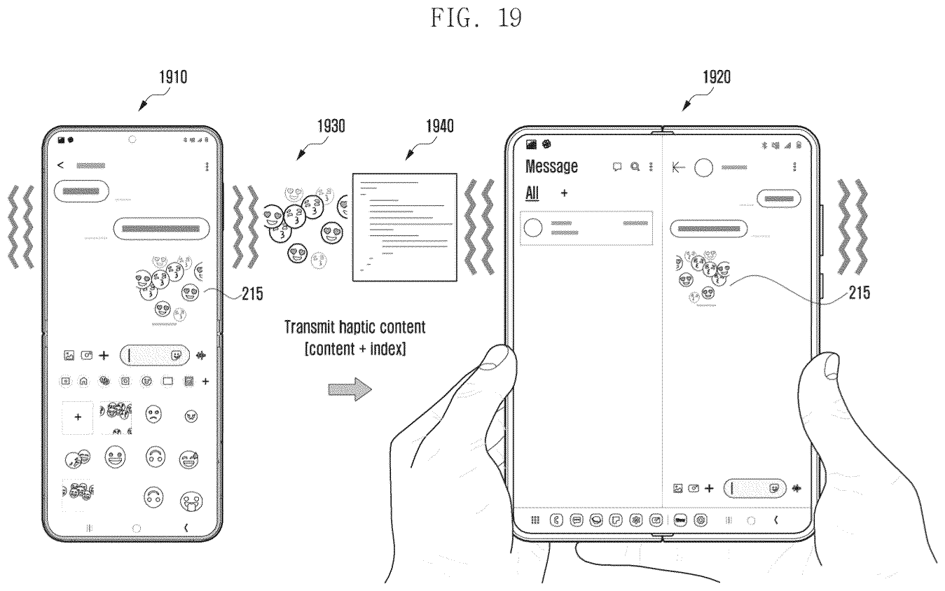

FIG. 19 is a diagram illustrating an example of sharing haptic content between electronic devices according to an embodiment of the disclosure.

Referring to FIG. 19, a system according to an embodiment may include a first electronic device 1910 that outputs haptic feedback (or vibration) corresponding to the haptic content 215 based on a user input, or shares (e.g., transmits) the haptic feedback with another external electronic device (e.g., a second electronic device 1920), and a second electronic device 1920 that receives the haptic content 215 from the first electronic device 1910 and outputs haptic feedback (or vibration) corresponding to the haptic content 215. According to an embodiment, the first electronic device 1910 and the second electronic device 1920 may correspond to the electronic device 101 as described in the description referring to FIG. 1, or may include all or at least some of the components of the electronic device 101. According to an embodiment, the first electronic device 1910 and the second electronic device 1920 may be classified for understanding the disclosure, and the first electronic device 1910 and the second electronic device 1920 may perform the same configuration and operation.

Hereinafter, the electronic device 101 that shares (e.g., transmits) the haptic content 215 is named as the first electronic device 1910, and the electronic device 101 that receives the haptic content 215 shared from the first electronic device 1910 and generates haptic feedback corresponding thereto is named as the second electronic device 1920 to describe an embodiment of the disclosure.

According to an embodiment, when a request to share the haptic content 215 occurs from the user, the first electronic device 1910 may identify content (e.g., content such as an emoticon, an image, a sound source, a video, and/or text as a content source) constituting the designated haptic content 215 and at least one index (e.g., vibration pattern information) capable of generating vibration with a designated vibration pattern through the content. According to an embodiment, the first electronic device 1910 may transmit haptic content to the second electronic device 1920 based on content 1930 and an index 1940 corresponding to the haptic content 215. According to an embodiment, the first electronic device 1910 may play back the pattern of the index stored in the first electronic device 1910 by extracting an index corresponding to PCM data (e.g., haptic data, original data, or wavelength data) rather than the entire PCM data (e.g., entire vibration patterns) proportional to the length of the haptic content. According to an embodiment, the first electronic device 1910 may convert the haptic content itself into various transmission formats (e.g., a protocol or packet in a text format) and transmit the same to the second electronic device 1920.

According to an embodiment, the second electronic device 1920 may receive haptic content transmitted from the first electronic device 1910. According to an embodiment, the second electronic device 1920 may receive the content 1930 and the index 1940 corresponding to the haptic content as haptic content. According to an embodiment, the second electronic device 1920 may extract the received content 1930 and the index 1940 as haptic content based on a trigger (e.g., a user input) for displaying the received haptic content. According to an embodiment, the second electronic device 1920 may configure a combination of vibration patterns (e.g., vibration magnitude (or level), pattern placement, scale, vibration length, and/or vibration delay) based on the index 1940, and may generate vibration in response to the vibration patterns to provide haptic feedback to the user.

According to an embodiment, in the case that the first electronic device 1910 shares the haptic content with the second electronic device 1920, when the haptic content is played back in the first electronic device 1910 and/or the second electronic device 1920, an index corresponding to the haptic content may be called, and a vibration pattern may be configured and played back based on the called index.

According to an embodiment, the system configuration illustrated in FIG. 19 is only an embodiment, and the system according to the disclosure may be applied to various applications based on the system configuration of FIG. 19. For example, the first electronic device 1910 may operate to share haptic content with a plurality of other electronic devices according to an operation method for sharing the user's haptic content.

According to an embodiment of the disclosure, when sharing haptic content, the first electronic device 1910 may transmit content including ID information of combinable minimum unit vibration patterns (e.g., basic patterns), vibration data corresponding to the placement of the basic patterns and additional information (e.g., scale, delay, and/or duration) to the second electronic device 1920. According to an embodiment of the disclosure, the second electronic device 1920 may analyze an index (e.g., ID information of minimum unit vibration patterns, arrangement of basic patterns, and additional information) included in the received content, and combine (e.g., reconstruct) each individual index corresponding to the minimum unit vibration pattern stored in the second electronic device 1920 based on the received index to play back the haptic feedback.

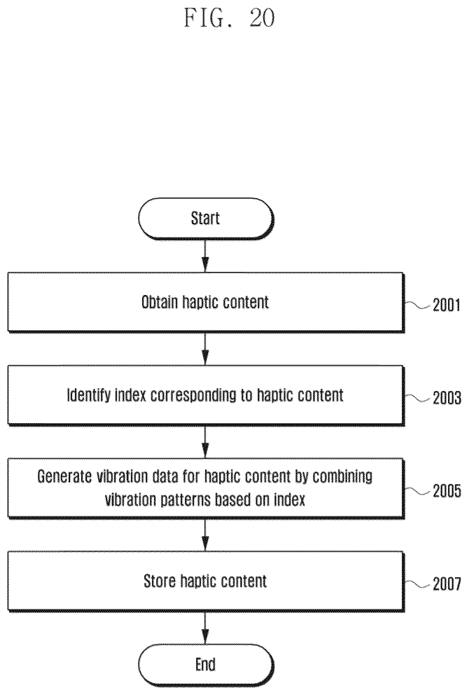

FIG. 20 is a flowchart illustrating an operation method of an electronic device according to an embodiment of the disclosure.

According to an embodiment, FIG. 20 may illustrate an example of an operation of providing a haptic service based on haptic content in the electronic device 101 according to an embodiment. According to an embodiment, FIG. 20 may illustrate an example of an operation in which the electronic device 101 receives haptic content shared (e.g., transmitted) by another electronic device and processes the received haptic content.

In the electronic device 101 according to an embodiment of the disclosure, a method of providing haptic content may be performed according to, for example, a flowchart illustrated in FIG. 20. The flowchart illustrated in FIG. 20 is only a flowchart according to an embodiment of processing an operation related to supporting a haptic service in the electronic device 101, and the order of at least some operations may be changed or performed in parallel, performed as independent operations, or at least some other operations may be performed complementarily to at least some operations. According to an embodiment of the disclosure, operations 2001 to 2007 may be performed by at least one processor 120 of the electronic device 101.

According to an embodiment, the operation described in FIG. 20 may be heuristically performed, for example, in combination with the operations described in FIGS. 5 to 19, or heuristically performed as a detailed operation of at least some of the described operations.

As illustrated in FIG. 20, an operation method (e.g., an operation method for supporting a haptic service based on obtaining haptic content from the outside) performed by the electronic device 101 according to an embodiment may include an operation 2001 of obtaining haptic content, an operation 2003 of identifying an index corresponding to the haptic content, an operation 2005 of generating vibration data for the haptic content by combining vibration patterns based on the index, and an operation 2007 of storing the haptic content.

Referring to FIG. 20, in operation 2001, the processor 120 of the electronic device 101 may perform an operation of obtaining haptic content. According to an embodiment, the processor 120 may receive haptic content transmitted by another electronic device (e.g., the first electronic device 1910 of FIG. 19) through a communication circuit (e.g., the communication module 190 of FIG. 1) of the electronic device 101 (e.g., the second electronic device 1920 of FIG. 19). According to an embodiment, the processor 120 may receive content and vibration pattern information corresponding to haptic content from another electronic device. According to an embodiment, when sharing haptic content, another electronic device may transmit content including ID information of combinable minimum unit vibration patterns (e.g., basic patterns), vibration pattern information corresponding to the placement of the basic patterns and additional information (e.g., scale, delay, and/or duration) to the electronic device 101.

In operation 2003, the processor 120 may perform an operation of identifying an index corresponding to the haptic content. According to an embodiment, the processor 120 may receive content and vibration data (or haptic data) in a designated format corresponding to the content as haptic content based on a trigger (e.g., a user input) displaying the received haptic content. According to an embodiment, the processor 120 may extract an index (e.g., a pattern identifier) from the received vibration data in a designated format. According to an embodiment, the processor 120 may call an index (e.g., an individual index) corresponding to a minimum unit vibration pattern (e.g., a basic pattern corresponding to ID information of the pattern) stored in a separate storage space (e.g., the memory 130).

In operation 2005, the processor 120 may perform an operation of generating vibration data for haptic content by combining vibration patterns based on indices. According to an embodiment, the processor 120 may generate a vibration pattern by combining the minimum unit vibration pattern according to the placement of the received index. According to an embodiment, the processor 120 may configure a corresponding vibration pattern by combining the called individual index according to information (e.g., vibration magnitude (or level), pattern placement, scale, vibration length, and/or vibration delay) according to the received index. According to an embodiment, the processor 120 may analyze vibration pattern information (e.g., index (or ID information) of minimum unit vibration patterns, arrangement of basic patterns, and additional information) included in the received content, and recombine (e.g., reconstruct) each individual index corresponding to the minimum unit vibration pattern stored in the electronic device 101 based on the received index.

According to an embodiment, the processor 120 may combine individual indices based on the received index. For example, the electronic device 101 may have different specifications of motors applied to each electronic device. According to an embodiment, the electronic device 101 may pre-store (e.g., pre-load) an index mapping table for each motor specification in the memory 130. According to an embodiment, the electronic device 101 may request the index mapping table according to the motor specification of another electronic device along with information on another electronic device (e.g., a transmission side electronic device) that transmits haptic content from an external device (e.g., a cloud server) from another device and download the same.

According to an embodiment, the processor 120 may map an index (e.g., index=10) corresponding to the first motor specification of the electronic device 101 and an index (e.g., index=19) corresponding to the second motor specification of another electronic device based on the index mapping table. For example, when the processor 120 receives the index “19” from another electronic device, the processor 120 may recombine based on the index “10” mapped to the index “19”.

In operation 2007, processor 120 may include an operation of storing haptic content. According to an embodiment, the processor 120 may store the haptic content in the memory 130 in which a vibration pattern (e.g., PCM data) and content are mapped based on a user request for generating (or storing) the haptic content. According to an embodiment, the processor 120 may generate haptic content by mapping a vibration pattern configured based on an index into PCM data as the corresponding content, and may store the generated haptic content in the memory 130. According to an embodiment, the processor 120 may operate to provide haptic feedback by reconstructing an index-based vibration pattern each time when playing back haptic content, or to provide haptic feedback based on PCM data corresponding to the haptic content. According to an embodiment, the processor 120 may include an operation of receiving a playback request for the haptic content of the user in parallel or generally in an operation of storing the haptic content. According to an embodiment, the electronic device 101 may provide haptic feedback to the user by generating vibration in response to a vibration pattern configured based on an index in response to a playback request for the user's haptic content.

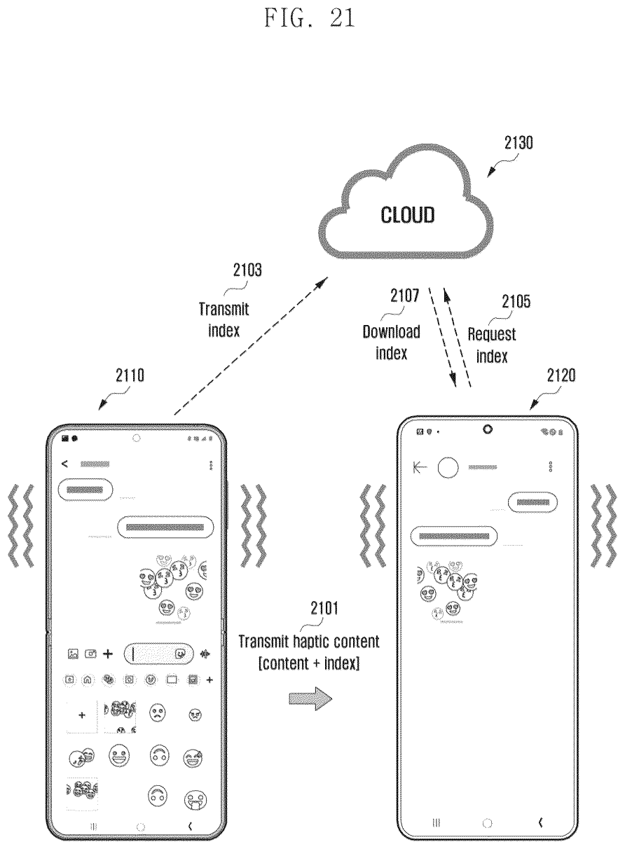

FIG. 21 is a diagram illustrating an example of sharing an index for haptic content between electronic devices according to an embodiment of the disclosure.

According to an embodiment, FIG. 21 may illustrate an example of an operation that supports processing a vibration pattern that is not supported by the electronic device 101.

Referring to FIG. 21, the system according to an embodiment may include a first electronic device 2110 that outputs haptic feedback (or vibration) corresponding to haptic content based on a user input or shares (e.g., transmits) the haptic feedback with another external electronic device (e.g., a second electronic device 2120), and the second electronic device 2120 that receives the haptic content from the first electronic device 2110 and outputs haptic feedback (or vibration) corresponding to the haptic content. According to an embodiment, FIG. 21 may illustrate an example in which the system includes a user account-based cloud server 2130. According to an embodiment, the first electronic device 2110 and the second electronic device 2120 may correspond to the electronic device 101 as described in the description with reference to FIG. 1, or may include all or at least some of the components of the electronic device 101. According to an embodiment, the first electronic device 2110 and the second electronic device 2120 may be classified for understanding the disclosure, and the first electronic device 2110 and the second electronic device 2120 may perform the same configuration and operation.

According to an embodiment, when a user requests to share haptic content, the first electronic device 2110 may identify vibration pattern information including content (e.g., content such as an emoticon, an image, a sound source, a video, and/or text) that constitutes the designated haptic content and an index that may generate vibration with a designated vibration pattern through the content. According to an embodiment, the first electronic device 2110 may transmit the haptic content to the second electronic device 2120 based on the content and the index corresponding to the haptic content (operation 2101). According to an embodiment, the first electronic device 2110 may extract an index corresponding to PCM data (e.g., haptic data, original data, or wavelength data) rather than PCM data (e.g., entire vibration patterns) configured in haptic content, transform the extracted index and the content of the haptic content into a designated message format (e.g., a protocol or packet in a text format) and transmit the same to the second electronic device 2120.

According to an embodiment, when sharing haptic content, the first electronic device 2110 may perform an operation of registering by transmitting an index (or vibration pattern information) related to the vibration pattern of the haptic content to the cloud server 2130 (operation 2103).

According to an embodiment, the second electronic device 2120 may receive the haptic content transmitted from the first electronic device 2110. According to an embodiment, the second electronic device 2120 may receive content and an index (or vibration pattern information) corresponding to the haptic content as haptic content. According to an embodiment, the second electronic device 2120 may extract received content and an index as haptic content based on a trigger (e.g., a user input) for displaying the received haptic content. According to an embodiment, the second electronic device 2120 may configure a vibration pattern (e.g., vibration magnitude (or level), pattern placement, scale, vibration length, and/or vibration delay) based on an index, and may generate vibration in response to the vibration pattern to provide haptic feedback to the user.

According to an embodiment, there may be a case in which the second electronic device 2120 may not process a vibration pattern corresponding to the haptic content obtained from the outside. For example, there may be no minimum unit vibration pattern corresponding to haptic content and an index (individual index) related thereto in the second electronic device 2120. According to an embodiment, when playing back haptic content, the second electronic device 2120 may request an index corresponding to the cloud server 2130 when it is determined that the corresponding vibration pattern may not be implemented (operation 2105). For example, the second electronic device 2120 may transmit ID information corresponding to the minimum unit vibration pattern of the haptic content to the cloud server 2130 and request an index corresponding to the ID information.

According to an embodiment, the cloud server 2130 may provide the requested index to the second electronic device 2120 based on receiving the request from the second electronic device 2120. According to an embodiment, when providing the index, the cloud server 2130 may also provide a minimum unit vibration pattern corresponding to ID information. According to an embodiment, the second electronic device 2120 may download an index 2107 from the cloud server 2130 and store the index in the memory (e.g., the memory 130 of FIG. 1) of the second electronic device 2120.

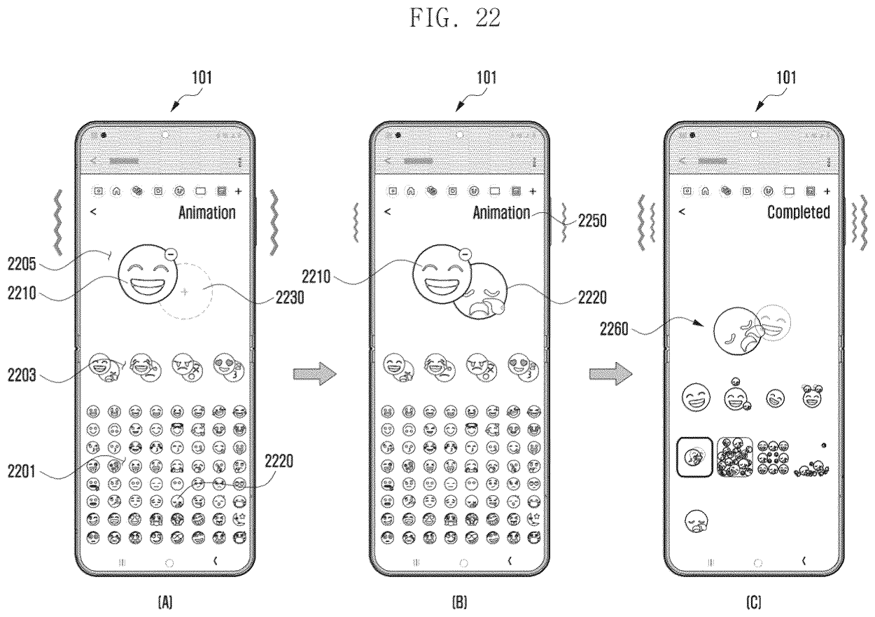

FIG. 22 is a diagram illustrating an example of generating haptic content in an electronic device according to an embodiment of the disclosure.

According to an embodiment, FIG. 22 may illustrate an example of generating haptic content (e.g., content (e.g., ambivalent emotion or identical emotional emoticon) and vibration data (or haptic data)) in the electronic device 101. According to an embodiment, the electronic device 101 may execute an application capable of generating (e.g., producing) haptic content based on a user input, and may perform a function of generating haptic content on the execution screen of the application. According to an embodiment, the electronic device 101 may start generating haptic content based on sensing a user input of selecting a function button (e.g., a production button) related to the generation of haptic content on the execution screen of the application, and may provide a user interface related to the generation of haptic content through a display (e.g., the display module 160 of FIG. 1 or 4) to the execution screen of the application.

Referring to FIG. 22, an example screen A, an example screen B, and an example screen C may represent examples of displaying execution screens (e.g., user interfaces) related to the generation of haptic content. In an embodiment, FIG. 22 illustrates, but is not limited to, content for haptic content being an ambivalent emotion emoticon.

According to an embodiment, referring to the example screen A, a production user interface capable of producing emoticon-based haptic content may include a first area 2201, a second area 2203, and a third area 2205.

According to an embodiment, the first area 2201 may be configured (or stored) in the memory 130 of the electronic device 101 and may provide various emoticons (e.g., templates) indicating various emotions (or states) of the user. According to an embodiment, each of the various emoticons may be haptic content in which a vibration pattern capable of expressing a corresponding emotion (or state) as haptic feedback (e.g., vibration) is mapped in advance. According to an embodiment, the first area 2201 may correspond to a keyboard area. For example, based on the user input for emoticon input in the keyboard area, a keyboard with a designated key map of the keyboard area may be switched into a list of emoticons.

According to an embodiment, the second area 2203 may provide various pair emoticons. In an embodiment, the pair emoticon may represent haptic content capable of expressing a strong emotion or an ambivalent emotion by combining at least two emoticons corresponding to the same emotion or different emotions, respectively. In an embodiment, the pair emoticon may be haptic content previously produced by the user, and/or may be recommended haptic content that recommends a form that may be combined in the electronic device 101.

According to an embodiment, the third area 2205 may be an area that guides a form in which at least two emoticons selected by the user to generate new haptic content are combined. According to an embodiment, the electronic device 101 may provide a pair emoticon in which at least two emoticons are combined through the third area 2205 in response to an emoticon selected in response to the user input in the first area 2201.

According to an embodiment, the user may sequentially select (e.g., touch) a first emoticon 2210 representing a first emotion and a second emoticon 2220 representing a second emotion among various emoticons displayed in the first area 2201.

According to an embodiment, the example screen A may represent a state in which the first emoticon 2210 representing the first emotion is selected by the user in the first area 2201. According to an embodiment, the electronic device 101 may display the first emoticon 2210 selected based on the first area 2201 by the user on the third area 2205. According to an embodiment, the electronic device 101 may provide an emoticon selected by the user to generate haptic content to the third area 2205, and may guide whether a combinable emoticon may be added through a designated object 2230 (e.g., an additional object). According to an embodiment, when selecting the first emoticon 2210 in the first area 2201 (or displaying the first emoticon 2210 in the third area 2205), the electronic device 101 may play back first vibration data (or haptic data) corresponding to the first emoticon 2210.

According to an embodiment, the example screen B may represent a state in which the second emoticon 2220 representing the second emotion is selected by the user in the first area 2201. According to an embodiment, the electronic device 101 may display the second emoticon 2220 selected based on the first area 2201 by the user together with the previously selected first emoticon 2210 on the third area 2205. For example, the selected second emoticon 2220 may be added and displayed on the area of the designated object 2230. According to an embodiment, when selecting the second emoticon 2220 in the first area 2201 (or displaying the second emoticon 2220 in the third area 2205), the electronic device 101 may play back second vibration data (or haptic data) corresponding to the second emoticon 2220.

According to an embodiment, as illustrated in the example screen C, based on a user input for playback in advance (e.g., touching the animation button 2250), the electronic device 101 may generate and provide an animation to a pair emoticon 2260 according to a combination of the first emoticon 2210 representing the first emotion and the second emoticon 2220 representing the second emotion. According to an embodiment, when generating the animation, the electronic device 101 may play back hybrid vibration data (or hybrid haptic data) in which the first vibration data of the first emoticon 2210 and the second vibration data of the second emoticon 2220 are combined.

In an embodiment, the hybrid vibration data may include, for example, a combination of first vibration data, transition vibration data (transition haptic data) (or a transition effect or an animation effect) and second vibration data. In an embodiment, the transition vibration data may include, for example, vibration data (or haptic data) for a transition effect from the first vibration data to the second vibration data. According to an embodiment, the transition vibration data is described with reference to the drawings described below.

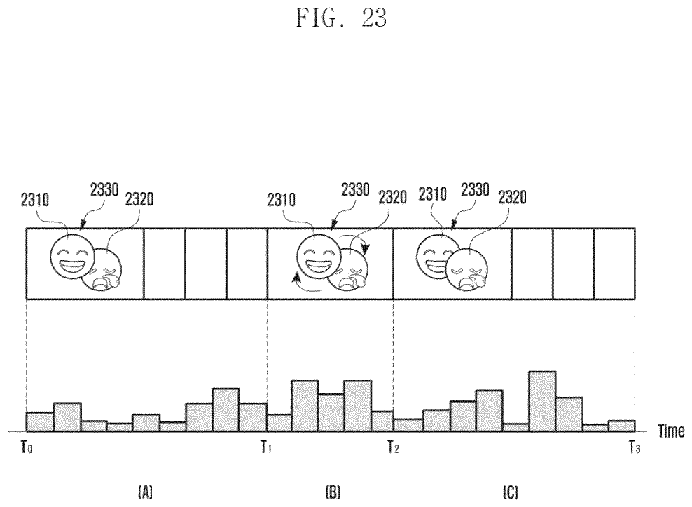

FIG. 23 is a diagram illustrating an example of playing back haptic content in an electronic device according to an embodiment of the disclosure.

According to an embodiment, FIG. 23 may illustrate an example of playing back a pair emoticon (e.g., an ambivalent emotion emoticon) in the electronic device 101. For example, FIG. 23 may illustrate an example of generating and providing a transition vibration effect (transition haptic effect) (or an animation effect) according to the playback of a pair emoticon (e.g., an ambivalent emotional emoticon 2330) generated according to a combination of emoticons 2310 and 2320 representing different emotions (e.g., ambivalent emotions).

Referring to FIG. 23, the electronic device 101 may generate a transition vibration effect (e.g., fade in/fade out) according to a combination of the first emoticon 2310 of a first emotion (e.g., laughing) and the second emoticon 2320 of a second emotion (e.g., sad). According to an embodiment, the electronic device 101 may play back first vibration data (or first haptic data) corresponding to the first emoticon 2310 in the section A between T0 and T1 on the time axis, play back third vibration data (or third haptic data) corresponding to a transition vibration effect (e.g., fade in/fade out) in the section B between T1 and T2, and play back second vibration data (or second haptic data) corresponding to the second emoticon 2320 in the section C between T2 and T3. According to an embodiment, for example, the transition vibration effect may provide an animation effect for transitioning the locations (e.g., upper and lower locations or layers) of the first emoticon 2310 and the second emoticon 2320 while playing back the intensity of at least some of the minimum vibration patterns of the first vibration data gradually weaker and playing back the intensity of at least some of the minimum vibration patterns of the second vibration data gradually stronger.

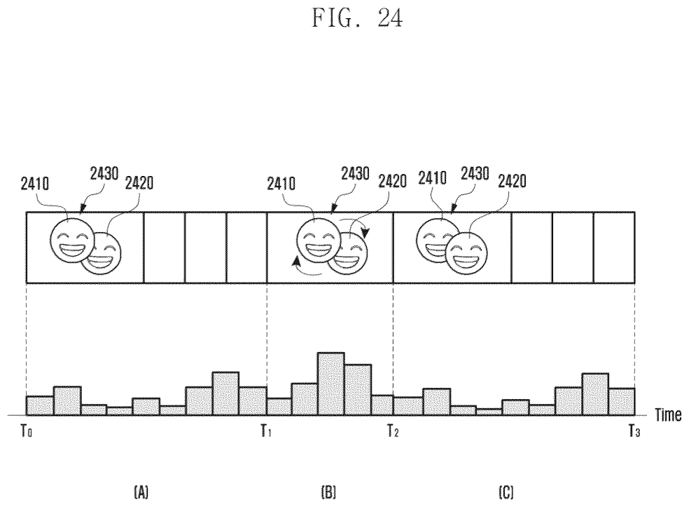

FIG. 24 is a diagram illustrating an example of playing back haptic content in an electronic device according to an embodiment of the disclosure.

According to an embodiment, FIG. 24 may illustrate an example of playing back a pair emoticon (e.g., an identical emotion emoticon) in the electronic device 101. For example, FIG. 24 may illustrate an example of generating and providing a transition vibration effect (transition haptic effect) (or an animation effect) according to the playback of a pair emoticon (e.g., a strong emotional emoticon 2430) generated according to a combination of emoticons 2410 of the same emotion.

Referring to FIG. 24, the electronic device 101 may generate a transition vibration effect (e.g., bounce) according to a combination of two emoticons 2410 and 2420 of the same emotion (e.g., laughing). According to an embodiment, the electronic device 101 may play back first vibration data (or first haptic data) corresponding to the emoticon 2410 in the section A between T0 and T1 on the time axis, play back third vibration data (or third haptic data) corresponding to a transition vibration effect (e.g., bounce) in the section B between T1 and T2, and play back first vibration data (or first haptic data) corresponding to the emoticon 2410 in the section C between T2 and T3. According to an embodiment, for example, the transition vibration effect may provide an animation effect for transitioning the locations (e.g., upper and lower locations or layers) between two emoticons 2410 and 2420 of the same emotion while playing back by adjusting the intensity and/or delay of at least a part of the minimum vibration patterns of the first vibration data and at least a part of the minimum vibration patterns of the third vibration data (e.g., bounce).

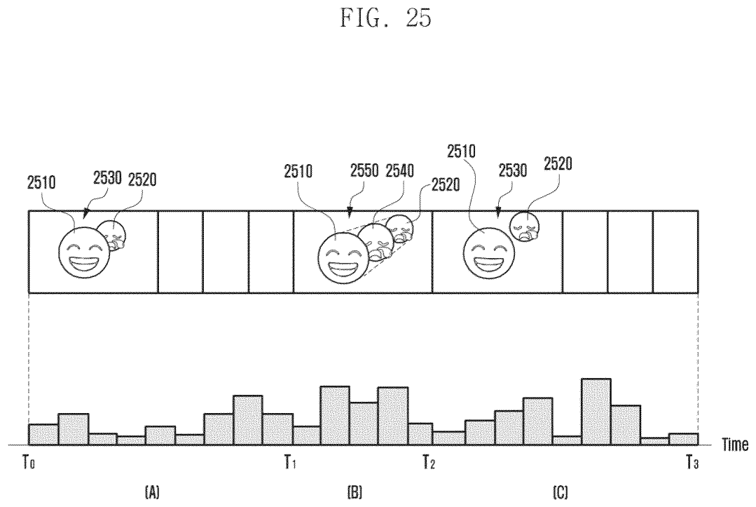

FIG. 25 is a diagram illustrating an example of playing back haptic content in an electronic device according to an embodiment of the disclosure.

According to an embodiment, FIG. 25 may illustrate an example of playing back a pair emoticon (e.g., an ambivalent emotion emoticon) in the electronic device 101. For example, FIG. 25 may illustrate an example of generating and providing a transition vibration effect (transition haptic effect) (or an animation effect) according to the playback of a pair emoticon (e.g., an ambivalent emotional emoticon 2530) generated according to a combination of emoticons 2510 and 2520 representing different emotions (e.g., ambivalent emotions).

Referring to FIG. 25, the electronic device 101 may generate a transition vibration effect (e.g., far away) according to a combination of the first emoticon 2510 of a first emotion (e.g., laughing) and the second emoticon 2520 of a second emotion (e.g., sad). According to an embodiment, the electronic device 101 may play back first vibration data (or first haptic data) corresponding to the first emoticon 2510 in the section A between T0 and T1 on the time axis, play back third vibration data (or third haptic data) corresponding to a transition vibration effect 2550 (e.g., far away) in the section B between T1 and T2, and play back second vibration data (or second haptic data) corresponding to the second emoticon 2520 in the section C between T2 and T3. According to an embodiment, the transition vibration effect may provide different transition vibration effects (e.g., fade in/fade out or far away) for the same pair emoticons 2330 and 2530 as compared to FIG. 23.

For example, the electronic device 101 may provide a different transition vibration effect (e.g., a transition vibration effect (e.g., fade in/fade out) according to FIG. 23 or a transition vibration effect (e.g., far away) according to FIG. 25) for a combination of the first emoticon (e.g., laughing) and the second emoticon (e.g., sad). For example, according to the example of FIG. 25, the transition vibration effect may provide an animation effect in which the emoticons are sequentially reduced (or weakened) by adding a third emoticon 2540 between the first emoticon 2510 and the second emoticon 2520 while repeatedly playing back the intensity gradually weaker by adding at least a part of the minimum vibration patterns of the first vibration data and the third vibration data corresponding to at least a part of the minimum vibration patterns of the second vibration data between the first vibration data and the second vibration data

An operation method performed by the electronic device 101 according to an embodiment of the disclosure may include sensing playback of haptic content. The operation method according to an embodiment may include identifying an index corresponding to a combination of minimum unit vibration patterns for haptic feedback in the haptic content. The operation method according to an embodiment may include combining the vibration patterns based on the index to generate vibration data for haptic content. The operation method according to an embodiment may include providing haptic feedback based on the vibration data.

According to an embodiment, the haptic content may include content and an index in a text format. According to an embodiment, the content may include all types of files such as an emoticon, an image, a sound source, a video, and/or text that are capable of being expressed in an electronic device. According to an embodiment, the index may include vibration pattern information corresponding to a combination of individual indices of the minimum unit vibration pattern.

According to an embodiment, the index may be configured in a text format including information on ID information, duration, scale, and/or delay of a pattern capable of distinguishing minimum unit vibration patterns.

According to an embodiment, the vibration pattern information may include information indicating a difference in vibration intensity, information indicating a difference in vibration length, information indicating a difference in vibration speed, operating information related to the vibration pattern, and/or information on delay time to the next vibration pattern.

According to an embodiment, the minimum unit vibration pattern may include a basic pattern that forms a vibration pattern defined to express the emotion corresponding to the content as vibration.

According to an embodiment, the operation method may include calling an index corresponding to the vibration pattern configured in the haptic content from a designated memory when sensing the playback of the haptic content. According to an embodiment, the operation method may include reconstructing a vibration pattern based on the called index to provide haptic feedback when playing back the haptic content.

According to an embodiment, the operation method may include extracting a meaningful designated feature point from the content, generating at least one individual index based on minimum unit vibration pattern corresponding to the extracted feature point, and generating a vibration pattern for haptic content based on a combination of at least one individual indices.

According to an embodiment, the operation method may include transmitting, to an external device, content including ID information of minimum unit vibration patterns capable of being combined, placement of minimum unit vibration patterns, and vibration data corresponding to additional information when sharing the haptic content with the external device.

According to an embodiment, the operation method may include receiving haptic content from an external device, analyzing an index included in the haptic content, combining each individual index corresponding to a pre-stored minimum unit vibration pattern based on the received index, and implementing a vibration pattern corresponding to the combination of individual indices to play back haptic feedback.

The various embodiments of the disclosure disclosed in this specification and drawings are merely specific examples presented to explain the technical content of the disclosure and to help understand the disclosure, and are not intended to limit the scope of the disclosure. Therefore, the scope of the disclosure should be interpreted as including all changes or modified forms derived based on the technical idea of the disclosure in addition to the embodiments disclosed herein.

What is claimed is:

1. An electronic device comprising:
a haptic driver;
memory storing instructions; and
at least one processor operatively connected to the haptic driver and the memory,
wherein the instructions, when executed by the at least one processor individually or collectively, cause the electronic device to:
sense playback of haptic content by the electronic device;
identify, in the haptic content, an index corresponding to a combination of minimum unit vibration patterns for haptic feedback;
combine the minimum unit vibration patterns based on the index to generate vibration data for haptic content; and
provide the haptic feedback based on the vibration data using the haptic driver.

2. The electronic device of claim 1, wherein the haptic content comprises content and the index in a text format,
wherein the content comprises at least one of an emoticon, an image, a sound, a video, or text, and
wherein the index comprises vibration pattern information corresponding to a combination of individual indices of the minimum unit vibration patterns.

3. The electronic device of claim 2, wherein the index comprises one or more of pattern identifier (ID) information, duration, scale, or delay of a vibration pattern capable of distinguishing minimum unit vibration pattern, and
wherein the vibration pattern information comprises information indicating at least one of vibration intensity, vibration length, vibration speed, operating information, or a delay time to a next vibration pattern.

4. The electronic device of claim 1,
wherein each of the minimum unit vibration patterns comprises a basic pattern that forms a vibration pattern defined to express an emotion corresponding to the haptic content.

5. The electronic device of claim 1, wherein the instructions, when executed by the at least one processor individually or collectively, further cause the electronic device to:
call an index corresponding to a vibration pattern configured in the haptic content from a designated memory when sensing playback of the haptic content; and
reconstruct the vibration pattern based on the called index to provide the haptic feedback when playing back the haptic content.

6. The electronic device of claim 2, wherein the instructions, when executed by the at least one processor individually or collectively, further cause the electronic device to combine minimum unit vibration patterns of a same type in response to an emotion represented by the content.

7. The electronic device of claim 2, wherein the instructions, when executed by the at least one processor individually or collectively, further cause the electronic device to combine minimum unit vibration patterns of a different type in response to an emotion represented by the content.

8. The electronic device of claim 2, wherein the instructions, when executed by the at least one processor individually or collectively, further cause the electronic device to:
extract a designated feature point from the content;
generate at least one individual index based on a minimum unit vibration pattern corresponding to the designated feature point; and
generate a vibration pattern for haptic content based on a combination of the at least one individual index.

9. The electronic device of claim 8, wherein the instructions, when executed by the at least one processor individually or collectively, further cause the electronic device to:
extract, from the content, at least one designated feature point based on at least one of an object, a word, a string, a time, a place, or an occasion corresponding to the user's emotion;
recognize at least one emotion corresponding to the at least one designated feature point; and
provide a vibration pattern and haptic content based on a combination of the at least one individual index of the minimum unit vibration pattern corresponding to the at least one emotion.

10. The electronic device of claim 1, wherein the instructions, when executed by the at least one processor individually or collectively, further cause the electronic device to, based on sharing the haptic content with an external device, transmit, to the external device, content comprising pattern identifier (ID) information of minimum unit vibration patterns capable of being combined, placement of minimum unit vibration patterns, and vibration data corresponding to additional information.

11. The electronic device of claim 1, wherein the instructions, when executed by the at least one processor individually or collectively, further cause the electronic device to:
receive haptic content from an external device;
analyze an index included in the haptic content received from the external device;
based on the received index, combine individual indices corresponding to pre-stored minimum unit vibration patterns; and
play back the haptic feedback, through the haptic driver, using a vibration pattern corresponding to the combination of individual indices.

12. A method of operating an electronic device, the method comprising:
sensing playback of haptic content by the electronic device;
identifying, in the haptic content, an index corresponding to a combination of minimum unit vibration patterns for haptic feedback;
combining the minimum unit vibration patterns based on the index to generate vibration data for haptic content; and
providing the haptic feedback based on the vibration data using a haptic driver of the electronic device.

13. The method of claim 12, wherein the haptic content comprises content and the index in a text format,
wherein the content comprises at least one of an emoticon, an image, a sound source, a video, or text capable of being output by the electronic device,
wherein the index comprises vibration pattern information corresponding to a combination of individual indices of the minimum unit vibration patterns, and
wherein each of the minimum unit vibration patterns comprises a basic pattern that forms a vibration pattern defined to express an emotion corresponding to the content.

14. The method of claim 13, wherein the index comprises at least one of pattern identification (ID) information, duration, scale, or delay of a vibration pattern capable of distinguishing minimum unit vibration patterns, and
wherein the vibration pattern information comprises information indicating at least one of vibration intensity, vibration length, vibration speed, operating information, or a delay time to a next vibration pattern.

15. The method of claim 12, further comprising:
calling an index corresponding to a vibration pattern configured in the haptic content from a designated memory when sensing playback of the haptic content; and
reconstructing the vibration pattern based on the called index to provide the haptic feedback when playing back the haptic content.

16. The method of claim 13, further comprising:
combining minimum unit vibration patterns of a same type in response to an emotion represented by the content.

17. The method of claim 13, further comprising:
combining minimum unit vibration patterns of a different type in response to an emotion represented by the content.

18. A non-transitory computer-readable medium having instructions stored thereon, which when executed by at least one processor of an electronic device, cause the at least one processor to execute a method of operating the electronic device, the method comprising:
sensing playback of haptic content by the electronic device;
identifying, in the haptic content, an index corresponding to a combination of minimum unit vibration patterns for haptic feedback;
combining the minimum unit vibration patterns based on the index to generate vibration data for haptic content; and
providing the haptic feedback based on the vibration data using a haptic driver of the electronic device.

19. The non-transitory computer-readable medium of claim 18,
wherein the haptic content comprises content and the index in a text format,
wherein the content comprises at least one of an emoticon, an image, a sound source, a video, or text capable of being output by the electronic device,
wherein the index comprises vibration pattern information corresponding to a combination of individual indices of the minimum unit vibration patterns, and
wherein each of the minimum unit vibration patterns comprises a basic pattern that forms a vibration pattern defined to express an emotion corresponding to the content.

20. The non-transitory computer-readable medium of claim 18,
wherein the index comprises at least one of pattern identification (ID) information, duration, scale, or delay of a vibration pattern capable of distinguishing minimum unit vibration patterns, and
wherein the vibration pattern information comprises information indicating at least one of vibration intensity, vibration length, vibration speed, operating information, or a delay time to a next vibration pattern.
